(19) United States
(12) Patent Application Publication
(10) Pub. No.: US 2023/0262546 A1
(43) Pub. Date: Aug. 17, 2023

(54) DUAL ACTIVE PROTOCOL STACK AND CONNECTION/LINK FAILURE HANDLING

(71) Applicant: Telefonaktiebolaget LM Ericsson (publ), Stockholm (SE)

(72) Inventors: Oumer Teyeb, MONTRÉAL (CA); Antonino Orsino, KIRKKONUMMI (FI); Pradeepa Ramachandra, LINKÖPING (SE)

(21) Appl. No.: 18/015,947

(22) PCT Filed: Jul. 15, 2021
(86) PCT No.: PCT/SE2021/050728

§ 371 Date: Jan. 12, 2023

Related U.S. Application Data
(60) Provisional application No. 63/052,687, filed on Jul. 16, 2020.

(51) Int. Cl. H04W 36/00; H04W 36/18; H04W 36/30; H04W 76/19

(52) U.S. Cl. CPC H04W 36/0079; H04W 36/18; H04W 36/305; H04W 76/19; H04W 36/0069

(57) ABSTRACT

A wireless communication device and a method performed by the device, enabled to perform a Dual Active Protocol Stack handover (HO) from a source node/cell to a target node/cell is provided. Responsive to detecting a radio link failure, RLF, on a source link between the device and the source node/cell, a RLF report related to the source node/cell is generated. Responsive to detecting a RLF on a target link between the device and the target node/cell, a RLF report related to the target node/cell is generated. An indication is included on a subsequent uplink RRC message to a network node that the device has one or more RLF reports related to DAPS HO failure. Responsive to receiving a request from the network node to send the one or more RLF reports, the one or more RLF reports are transmitted to the node.

### TECHNICAL FIELD

The present disclosure relates generally to communications, and more particularly to communication methods and related devices and nodes supporting wireless communications.

### BACKGROUND

In 3GPP, the dual-connectivity (DC) solution has been specified, both for LTE (long term evolution) and between LTE and NR (new radio). In DC two nodes are involved, a master node (MN or MeNB) and a Secondary Node (SN, or SeNB). Multi-connectivity (MC) is the case when there are more than 2 nodes involved. It has also been proposed in 3GPP that DC is used in the Ultra Reliable Low Latency Communications (URLLC) cases in order to enhance the robustness and to avoid connection interruptions.

There are different ways to deploy a 5G network with or without interworking with LTE (also referred to as Evolved Universal Terrestrial Radio Access (E-UTRA)) and evolved packet core (EPC), as depicted in FIG. 1. In principle, NR and LTE can be deployed without any interworking, denoted by NR stand-alone (SA) operation, that is gNB in NR can be connected to the 5G core network (5GC) and eNB can be connected to EPC with no interconnection between the two (Option 1 and Option 2 in FIG. 1). On the other hand, the first supported version of NR is the so-called EN-DC (Evolved Universal Terrestrial Radio Access Network (E-UTRAN)-NR Dual Connectivity), illustrated by Option 3 in FIG. 1. In such a deployment, dual connectivity between NR and LTE is applied with LTE as the master and NR as the secondary node. The RAN node (gNB) supporting NR, may not have a control plane connection to core network (EPC), instead it relies on the LTE as master node (MeNB). This is also called as “Non-standalone NR”. Notice that in this case the functionality of an NR cell is limited and would be used for connected mode UEs as a booster and/or diversity leg, but an RRC_IDLE UE cannot camp on these NR cells.

With introduction of 5GC, other options may be also valid. As previously mentioned, option 2 supports stand-alone NR deployment where the gNB is connected to the 5GC. Similarly, LTE can also be connected to the 5GC using option 5 in FIG. 1 (which is also known as eLTE, E-UTRA/5GC, or LTE/5GC). In these cases, both NR and LTE are seen as part of the NG-RAN. It is worth noting that, Option 4/4A and option 7/7A illustrated in FIG. 1 are other variants of dual connectivity between LTE and NR which will be standardized as part of NG-RAN connected to 5GC, denoted by MR-DC (Multi-Radio Dual Connectivity). Option 6 and 8, where the gNB is connected to the EPC (with and without interconnectivity to LTE) are also possible, but seem to be less practical and are not being pursued further in 3GPP.

Under the MR-DC umbrella, we have:
EN-DC (Option 3): LTE is the master node and NR is the secondary (EPC CN employed)
NE-DC (Option 4): NR is the master node and LTE is the secondary (5GCN employed)
NGEN-DC (Option 7): LTE is the master node and NR is the secondary (5GCN employed)
NR-DC (variant of Option 2): Dual connectivity where both the master and secondary are NR (5GCN employed)

As migration for these options may differ from different operators, it is possible to have deployments with multiple options in parallel in the same network e.g. there could be an eNB base station supporting option 3, 5 and 7 in the same network and a NR base station supporting 2 and 4. In combination with dual connectivity solutions between LTE and NR, it is also possible to support CA (Carrier Aggregation) in each cell group (i.e. master cell group (MCG) and secondary cell group (SCG)) and dual connectivity between nodes on the same RAT (e.g. NR-NR DC). For the LTE cells, a consequence of these different deployments is the co-existence of LTE cells associated to eNBs connected to EPC, 5GC or both EPC/5GC.

DC is standardized for both LTE and E-UTRA-NR DC (EN-DC).

LTE DC and EN-DC are designed differently when it comes to which nodes control what. Basically, there are two options:

1. Centralized solution (like LTE-DC), and

2. Decentralized solution (like EN-DC).

FIG. 2 illustrates the schematic control plane architecture looks like for LTE DC and EN-DC. The main difference between LTE DC and EN-DC is that in EN-DC, the SN has a separate RRC entity (NR RRC). This means that the SN can also control the UE; sometimes without the knowledge of the MN but often the SN need to coordinate with the MN. In LTE-DC, the RRC decisions are always coming from the MN (MN to UE). Note however, the SN still decides the configuration of the SN, since it is only the SN itself that has knowledge of what kind of resources, capabilities etc. the SN has.

For EN-DC, the significant changes compared to LTE DC are:
The introduction of split bearer from the SN (known as SCG split bearer)
The introduction of split bearer for RRC
The introduction of a direct RRC from the SN (also referred to as SCG SRB)

FIGS. 3 and 4 show the User Plane (UP) and Control Plane (CP) architectures for EN-DC.

The SN is sometimes referred to as SgNB (where gNB is an NR base station), and the MN as MeNB in case the LTE is the master node and NR is the secondary node. In the other case where NR is the master and LTE is the secondary node, the corresponding terms are SeNB and MgNB.

Split RRC messages are mainly used for creating diversity, and the sender can decide to either choose one of the links for scheduling the RRC messages, or it can duplicate the message over both links. In the downlink, the path switching between the MCG or SCG legs or duplication on both is left to network implementation. On the other hand, for the UL, the network configures the UE to use the MCG, SCG or both legs. The terms “leg”, “path” and “RLC bearer” are used interchangeably throughout this specification.

Carrier Aggregation

When CA is configured, the UE only has one RRC connection with the network. Further, at RRC connection establishment/re-establishment/handover, one serving cell provides the NAS mobility information, and at RRC connection re-establishment/handover, one serving cell provides the security input. This cell is referred to as the Primary Cell (PCell). In addition, depending on UE capabilities, Secondary Cells (SCells) can be configured to form together with the PCell a set of serving cells. The configured set of serving cells for a UE therefore consists of one PCell and one or more SCells. Further, when dual connectivity is configured, it could be the case that one carrier under the SCG is used as the Primary SCell (PSCell). Hence, in this case we have one PCell and one or more SCell(s) over the MCG and one PSCell and one or more SCell(s) over the SCG.

The reconfiguration, addition and removal of SCells can be performed by RRC. At intra-RAT handover, RRC can also add, remove, or reconfigure SCells for usage with the target PCell. When adding a new SCell, dedicated RRC signalling is used for sending all required system information of the SCell i.e. while in connected mode, UEs need not acquire broadcasted system information directly from the SCells.

Radio Link Failure (RLF)

Radio Link Failure due to physical layer problems

A UE may lose coverage to the cell to which the UE is currently connected. This could occur in a situation when a UE enters a fading dip, or that a handover was needed as described above, but the handover failed. This is particularly true if the “handover region” is very short

The quality of the radio link is typically monitored in the UE e.g. on the physical layer, as described in 3GPP TS 38.300, TS 38.331 and TS 38.133, and summarized below.

Upon detection that the physical layer experiences problems according to criteria defined in TS 38.133, the physical layer sends an indication using the RRC protocol of the detected problems (out-of-sync indication). After a configurable number (N310) of such consecutive indications, a timer (T310) is started. If the link quality is not improved (recovered) while T310 is running (i.e. there are no N311 consecutive “in-sync” indications from the physical layer), a radio link failure is declared in the UE.

The relevant timers and counters described above are listed here for reference. The UE reads the timer-values from system information broadcasted in the cell. Alternatively, it is possible to configure the UE with UE-specific values of the timers and constants using dedicated signaling, i.e. where specific values are given to specific UEs with messages directed only to each specific UE.

| Timer | Start | Stop | At expiry |
|---|---|---|---|
| T310 | Upon detecting | Upon receiving N311 | If the T310 is kept in |
| | physical layer | consecutive in-sync | MCG: If AS security is not |
| | problems for the | indications from lower | activated: go to |
| | SpCell i.e. upon | layers for the SpCell, upon | RRC_IDLE else: initiate |
| | receiving N310 | receiving | the connection re- |
| | consecutive out-of- | RRCReconfiguration with | establishment procedure. |
| | sync indications | reconfigurationWithSync | If the T310 is kept in SCG, |
| | from lower layers. | for that cell group, and | Inform E-UTRAN/NR |
| | | upon initiating the | about the SCG radio link |
| | | connection re- | failure by initiating the |
| | | establishment procedure. | SCG failure information |
| | | Upon SCG release, if the | procedure as specified in |
| | | T310 is kept in SCG. | 5.7.3. |
| T311 | Upon initiating the | Upon selection of a | Enter RRC_IDLE |
| | RRC connection re- | suitable NR cell or a cell | |
| | establishment | using another RAT. | |
| | procedure | | |

| Constant | Usage |
|---|---|
| N310 | Maximum number of consecutive ″out-of-sync″ |
| | indications for the SpCell received from lower layers |
| N311 | Maximum number of consecutive ″in-sync″ |
| | indications for the SpCell received from lower layers |

NOTE: In NR, the T310 is used for both the MCG (master cell group) and SCG (secondary cell group) (i.e for NR-DC, (NG)EN-DC). However, for the case where the SN is running LTE (i.e. LTE-DC, NE-DC), the timer associated with the PSCell is T313.

| Timer | Start | Stop | At expiry |
|---|---|---|---|
| T313 | Upon detecting | Upon receiving N314 | Inform E-UTRAN about |
| | physical layer | consecutive in-sync | the SCG radio link failure |
| | problems for the | indications from lower | by initiating the SCG |
| | PSCell i.e. upon | layers for the PSCell, upon | failure information |
| | receiving N313 | initiating the connection | procedure as specified in |
| | consecutive out-of- | re-establishment | 5.6.13. |
| | sync indications | procedure, upon SCG | |
| | from lower layers | release and upon receiving | |
| | | RRCConnectionReconfigu | |
| | | ration including | |
| | | MobilityControlInfoSCG | |

If T310 expires for MCG, and as seen in FIG. 4, the UE initiates a connection re-establishment to recover the ongoing RRC connection. This procedure now includes cell selection by the UE. I.e. the RRC_CONNECTED UE shall now try to autonomously find a better cell to connect to, since the connection to the previous cell failed according to the described measurements (it could occur that the UE returns to the first cell anyway, but the same procedure is also then executed). Once a suitable cell is selected (as further described e.g. in TS 38.304), the UE requests to re-establish the connection in the selected cell. It is important to note the difference in mobility behaviour as an RLF results in UE based cell selection, in contrast to the normally applied network-controlled mobility.

If the re-establishment is successful (which depends, among other things, if the selected cell and the gNB controlling that cell was prepared to maintain the connection to the UE), then the connection between the UE and the gNB can resume.

A failure of a re-establishment means that the UE goes to RRC_IDLE and the connection is released. To continue communication, a new RRC connection has to be requested and established.

The reason for introducing the timers T31x and counters N31x described above is to add some freedom and hysteresis for configuring the criteria for when a radio link should be considered as failed (and recovered). This is desirable, since it would hurt the end-user performance if a connection is abandoned prematurely if it turned out that the loss of link quality was temporary, and the UE succeeded in recovering the connection without any further actions or procedures (e.g. before T310 expires, or before the counting reaches value N310).

RLF due to other reasons

In addition to the physical layer issues described above, RLF can be detected due to:
upon random access problem indication from MCG MAC; or
upon indication from MCG RLC that the maximum number of retransmissions has been reached; or
if connected as an Integrated Access Backhaul (IAB)-node (i.e. a relay node that is connected to the network via a wireless link), upon backhaul RLF indication received from the MCG (i.e. on the link to a parent node)
upon consistent uplink listen-before-talk (LBT) failure indication from MCG MAC (when operating in unlicensed spectrum)

Reduced mobility interruption in LTE/NR rel-16

During a handover, the duration between the time when the UE stops transmission/reception with the source node and the time when the target node resumes transmission/reception with the UE is known as Mobility interruption time. The longer the mobility interruption time, the longer the service (user plane data radio bearer) interruption. New services, such as URLLC (ultra-reliable low latency communication) are not tolerant to longer mobility interruption time. Due to this, in LTE/NR rel-16, mobility enhancements were specified to reduce the mobility interruption time to almost 0 ms. FIG. 6 illustrates the mobility interruption time in a legacy network (pre rel-16 LTE/NR).

The mechanism proposed in rel-16 is known as Dual Active Protocol Stack (DAPS) handover. DAPS enables the continued transmission/reception to/from the source cell even after receiving the handover request and simultaneous reception of user data from the source cell and the target cell. Once the random access procedure and synchronization is performed to the target cell, UL data can additionally be sent to the target cell. Data transmission/reception to the source cell is stopped once the UE gets a message from the target cell indicating the DAPS handover is done.

FIGS. 7A and 7B illustrates the DAPS handover procedure. This procedure consists of the steps described below.

Once the source node has decided to perform the DAPS handover (e.g. based on received measurement indicating degradation of the link between the UE and source), the source node sends a DAPS handover request to the target node. It should be noted that the DAPS is not necessarily applied to all DRBs (e.g. MBB bearers that have only a best effort QoS and can handle mobility interruption may not be included in the DAPS handover, which means that for such bearers, legacy operation will apply and there will be handover interruption).

If the target node accepts the DAPS handover request, the target node will respond with a DAPS handover request ACK (alternatively, the target could respond with a legacy handover request ACK, indicating DAPS is not to be applied).

The source node sends a DAPS handover command to the UE, indicating which DRBs are part of the DAPS handover.

At reception of HO Command with an indicator to perform DAPS handover (per DRB in drb-ToAddModList), the UE:
continues to send and receive user data on the DAPS DRB(s) in the source cell
handle the DRB(s) not configured with DAPS in a legacy way
suspends source cell SRBs
sets up a new connection to the target cell

The source node sends an EARLY FORWARDING TRANSFER (SN and HFN of the first forwarded DL PDCP SDU for each DAPS DRB) and starts forwarding DL data to the target node, while it continues to transmit DL data to the UE. The source node keeps forwarding UL data received from the UE to the EPC/5GC on the old path.

After completing RA in the target cell, the UE (for each DAPS DRB):
switch UL data transmission from source to target cell (retransmission of unacknowledged PDCP PDUs and transmission of new PDCP PDUs)
   The UE sends PDCP status Report (per DAPS DRB) to the target node
continues to receive DL data from the source cell.

The target node may perform PDCP duplication check of DL data forwarded from the source node based on the PDCP status report received from the UE, and refrain from sending the duplicated packets to the UE.

At reception of the HANDOVER SUCCESS message from the target node, the source node the source stops sending/receiving user data to/from the UE and sends SN STATUS TRANSFER message with final receiver and transmitter status. Legacy data forwarding of any pending DL data could also be performed.

At reception of the SN STATUS TRANSFER message, the target node sends a request to the UE to release the source cell connection (DAPS DRBs and SRBs). This triggers the UE to send a second PDCP Status Report (for each DAPS DRB mapped on RLC-AM).

From this point onwards, the UE transmits and receives user data in the target cell.

### SUMMARY

Different types of failures can happen during DAPS HO. For example, there can be RLF to the source, RLF to the target, or RLF to both. An example of RLF to both is when the UE receives the DAPS HO command and tries to perform RA towards the target cell. If this RA procedure fails and the UE declares RLF in target cell but tries to come back to source cell, but the timer T310 with the source node/cell has expired, then the UE declares RLF on source node/cell. So, the UE has two RLFs detected, one for the source node/cell and another with the target node/cell.

Currently, only the handling of RLF in the source node/cell is captured in 3GPP.

Various embodiments of inventive concepts provide mechanisms in which a UE involved in RLF reports the RLF concerning the source cell or/and target cell. The node receiving this RLF report, possibly containing two RLF reports concerning both the source and target cells, will identify if the source and/or target cells do not belong to it, and if so passes the RLF report(s) to the node(s) serving the source and/or target cell(s).

According to some embodiments of inventive concepts, a method performed by a wireless communication device, enabled to perform a Dual Active Protocol Stack (DAPS) handover, HO, from a source node/cell to a target node/cell includes, responsive to detecting a radio link failure, RLF, on a source link between the wireless communication device and the source node/cell, generating (1101) a RLF report related to the source node/cell. The method further includes, responsive to detecting a RLF on a target link between the wireless communication device and the target node/cell, generating (1105) a RLF report related to the target node/cell. The method further includes including (1109) an indication on a subsequent uplink radio resource control, RRC, message to a network node that the wireless communication device has one or more RLF reports related to DAPS HO failure. The method further includes responsive to receiving a request from the network node to send the one or more RLF reports, transmitting (1111) the one or more RLF reports to the network node.

A wireless communication device that performs analogous operations is also provided.

Without some of the various embodiments described herein, in case an RLF happens during DAPS HO on the source, target or both, important information typical of the RLF report are not sent to the network after re-establishing the connectivity with a new cell/node (or reverting back to the source), and this may lead to sub-optimal network decisions/configuration/operation.

According to other embodiments, a method performed by a first network node providing connectivity to a wireless communication device in a wireless network includes receiving (1201) a notification from the wireless communication device that the wireless communication device has a radio link failure, RLF, report. The method further includes transmitting (1203) an instruction message to the wireless communication device instructing the wireless communication device to send the RLF report. The method further includes receiving (1205) the RLF report. The method further includes responsive to the RLF report containing information about a failure during dual active protocol stack handover, DAPS HO, and the RLF report contains failure information related to a source node serving a source cell and the first network node is different from the source node serving the source cell, forwarding (1207) the RLF report to the source node serving the source cell. The method further includes responsive to the RLF report containing information about a failure during DAPS HO and the RLF report contains failure information related to a target node serving a target cell and the first network node is different from the target node serving the target cell, forwarding (1209) the RLF report to the target node serving the target cell. The method further includes responsive to the RLF report containing information about a failure during DAPS HO and the RLF report contains failure information related to a source cell and a target cell and the first network node is different from the source node serving the source cell and from the target node serving the target cell, forwarding (1211) the RLF report to the source node serving the source cell and the target node serving the target cell.

A network node that performs analogous operations is also provided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of LTE and NR interworking options;

FIG. 2 is a block diagram illustrating the control plane architecture for dual connectivity in LTE DC and EN-DC;

FIG. 3 is an illustration of network side protocol termination options for MCG, SCG and split bearers in MR-DC with EPC (EN-DC);

FIG. 4 is an illustration of network architecture for control plane in EN-DC;

FIG. 5 is an illustration of radio link failure due to physical layer problems;

FIG. 6 is a signaling diagram illustrating mobility interruption time;

FIGS. 7A and 7B are a signaling diagram illustrating DAPS handover;

FIG. 8 is a block diagram illustrating a wireless device UE according to some embodiments of inventive concepts;

FIG. 9 is a block diagram illustrating a radio access network RAN node (e.g., a base station eNB/gNB) according to some embodiments of inventive concepts;

FIG. 10 is a block diagram illustrating a core network CN node (e.g., an AMF node, an SMF node, etc.) according to some embodiments of inventive concepts;

FIG. 11 is a flow chart illustrating operations of a communication device UE according to some embodiments of inventive concepts;

FIGS. 12A and 12B are a flow chart illustrating operations of a network node according to some embodiments of inventive concepts;

FIG. 13 is a block diagram of a wireless network in accordance with some embodiments;

FIG. 14 is a block diagram of a user equipment in accordance with some embodiments

FIG. 15 is a block diagram of a virtualization environment in accordance with some embodiments;

FIG. 16 is a block diagram of a telecommunication network connected via an intermediate network to a host computer in accordance with some embodiments;

FIG. 17 is a block diagram of a host computer communicating via a base station with a user equipment over a partially wireless connection in accordance with some embodiments;

FIG. 18 is a block diagram of methods implemented in a communication system including a host computer, a base station and a user equipment in accordance with some embodiments;

FIG. 19 is a block diagram of methods implemented in a communication system including a host computer, a base station and a user equipment in accordance with some embodiments;

FIG. 20 is a block diagram of methods implemented in a communication system including a host computer, a base station and a user equipment in accordance with some embodiments; and

FIG. 21 is a block diagram of methods implemented in a communication system including a host computer, a base station and a user equipment in accordance with some embodiments.

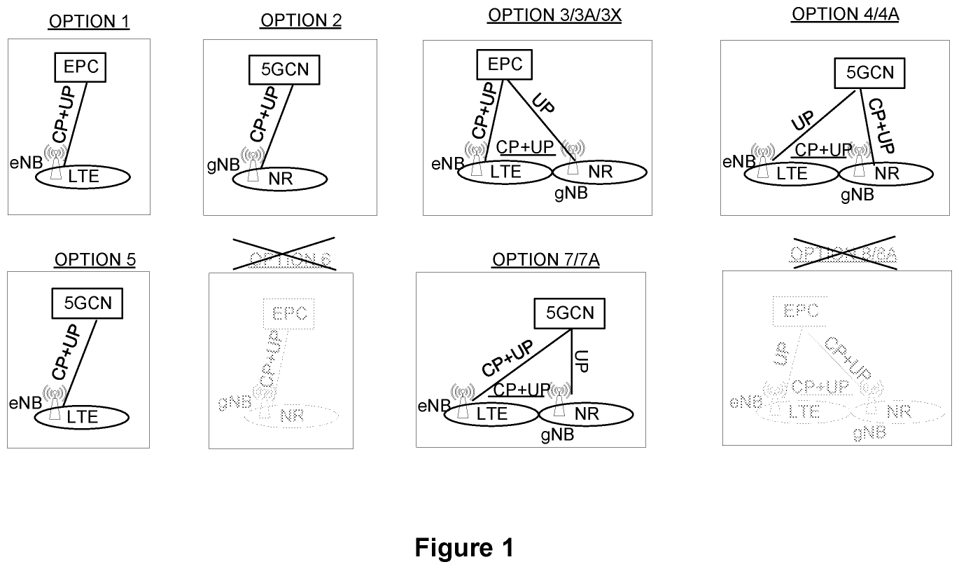

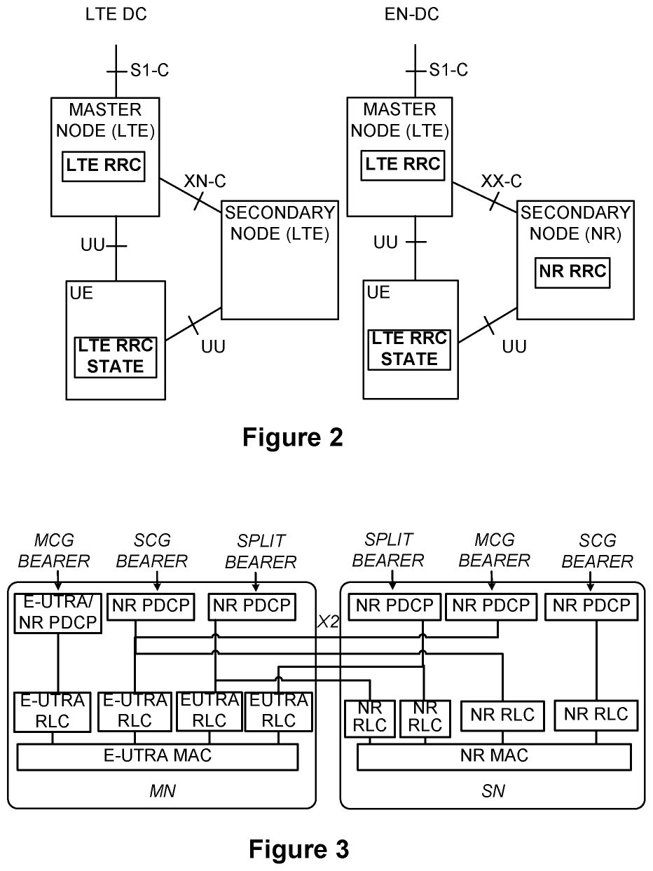

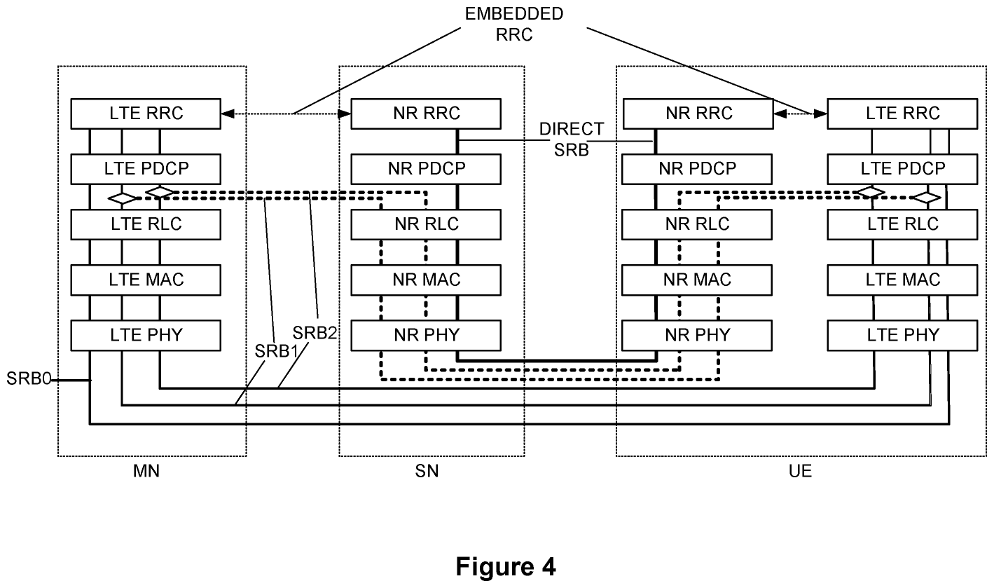

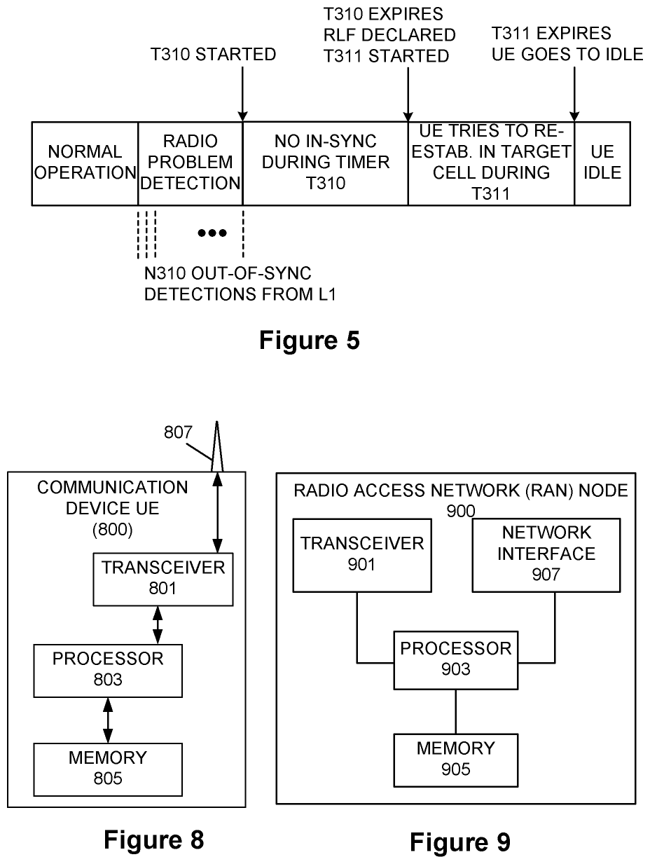

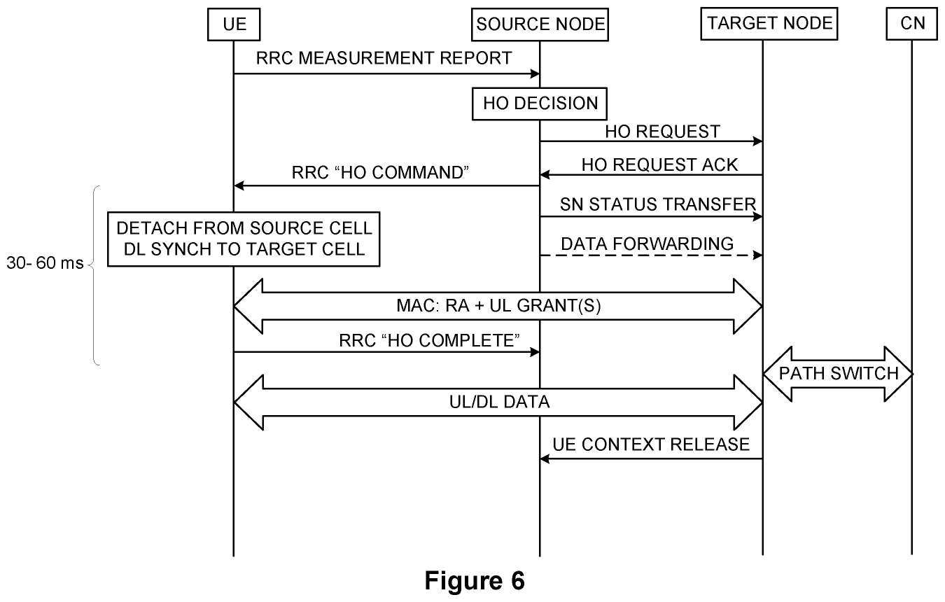

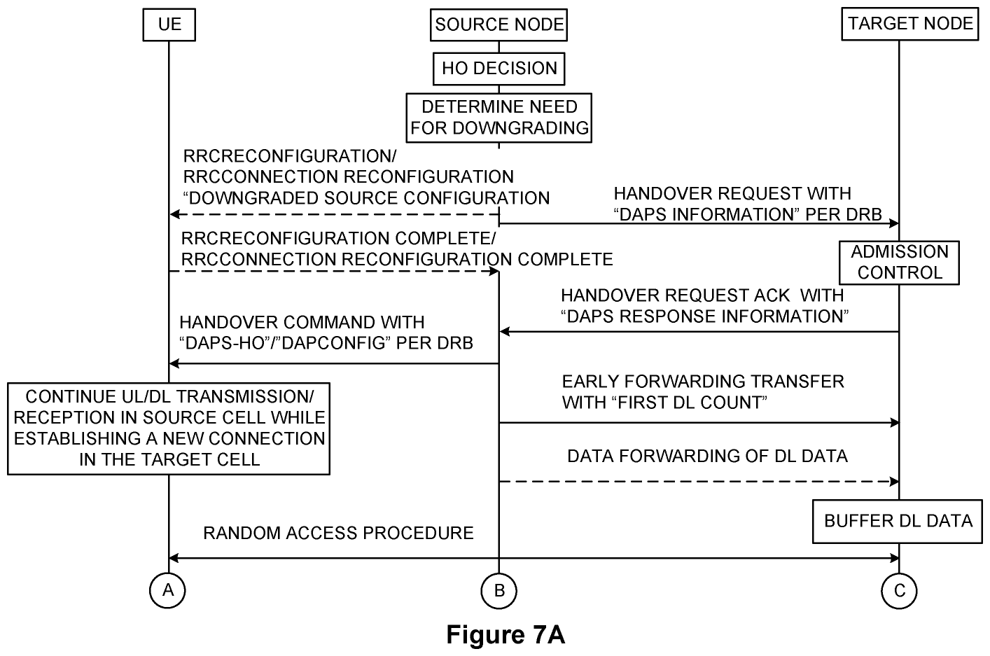

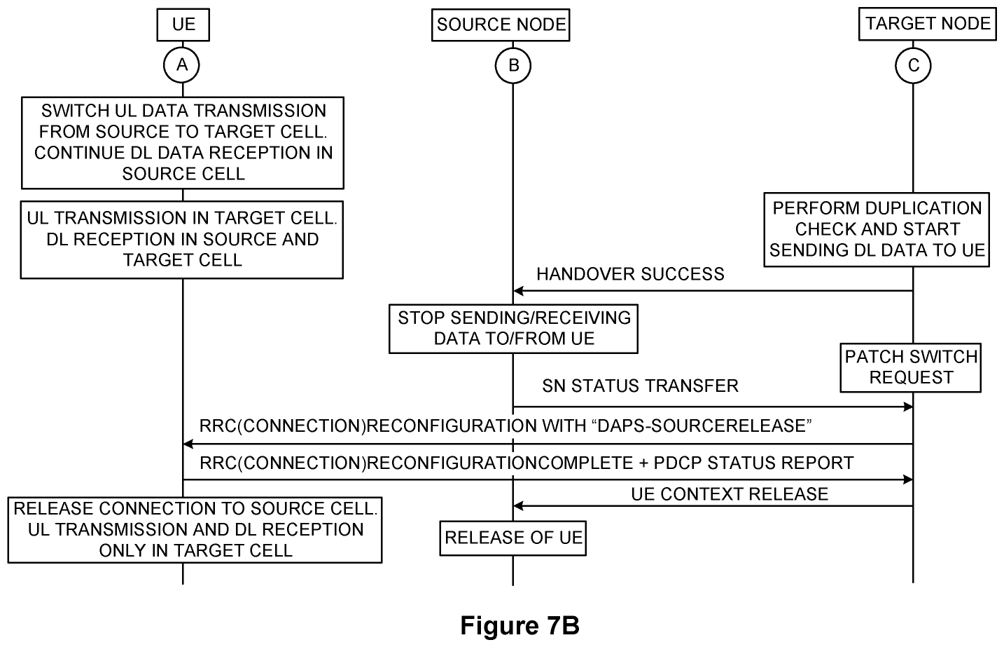

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

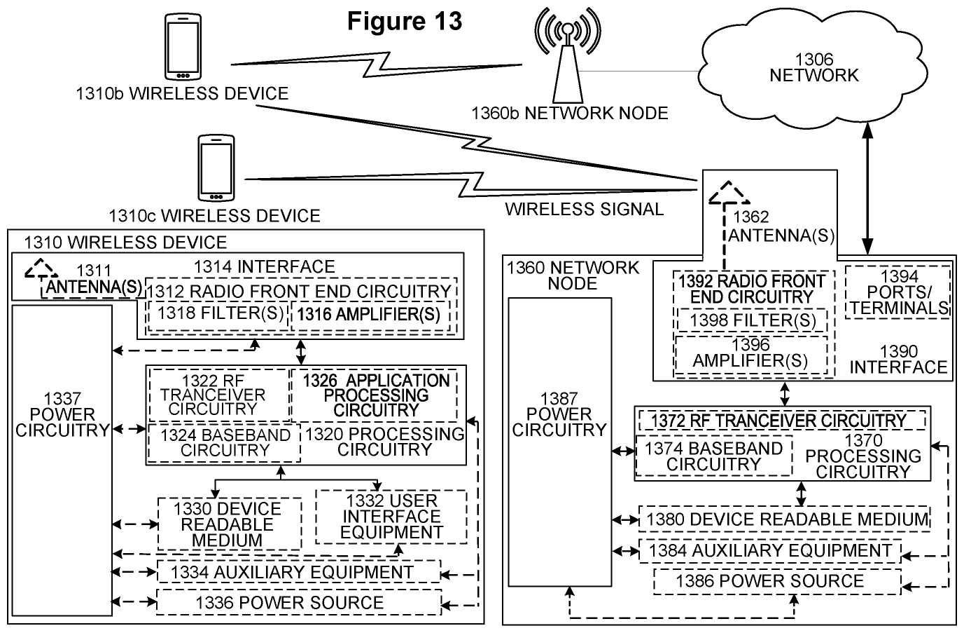

FIG. 8 is a block diagram illustrating elements of a communication device UE 800 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 800 may be provided, for example, as discussed below with respect to wireless device 1310 of FIG. 13.) As shown, communication device UE may include an antenna 807 (e.g., corresponding to antenna 1311 of FIG. 13), and transceiver circuitry 801 (also referred to as a transceiver, e.g., corresponding to interface 1314 of FIG. 13) including a transmitter and a receiver configured to provide uplink and downlink radio communications with a base station(s) (e.g., corresponding to network node 1360 of FIG. 13, also referred to as a RAN node) of a radio access network. Communication device UE may also include processing circuitry 803 (also referred to as a processor, e.g., corresponding to processing circuitry 1320 of FIG. 13) coupled to the transceiver circuitry, and memory circuitry 805 (also referred to as memory, e.g., corresponding to device readable medium 1330 of FIG. 13) coupled to the processing circuitry. The memory circuitry 805 may include computer readable program code that when executed by the processing circuitry 803 causes the processing circuitry to perform operations according to embodiments disclosed herein. According to other embodiments, processing circuitry 803 may be defined to include memory so that separate memory circuitry is not required. Communication device UE may also include an interface (such as a user interface) coupled with processing circuitry 803, and/or communication device UE may be incorporated in a vehicle.

As discussed herein, operations of communication device UE may be performed by processing circuitry 803 and/or transceiver circuitry 801. For example, processing circuitry 803 may control transceiver circuitry 801 to transmit communications through transceiver circuitry 801 over a radio interface to a radio access network node (also referred to as a base station) and/or to receive communications through transceiver circuitry 801 from a RAN node over a radio interface. Moreover, modules may be stored in memory circuitry 805, and these modules may provide instructions so that when instructions of a module are executed by processing circuitry 803, processing circuitry 803 performs respective operations (e.g., operations discussed below with respect to Example Embodiments relating to wireless communication devices). According to some embodiments, a communication device UE 800 and/or an element(s)/function(s) thereof may be embodied as a virtual node/nodes and/or a virtual machine/machines.

FIG. 9 is a block diagram illustrating elements of a radio access network RAN node 900 (also referred to as a network node, base station, eNodeB/eNB, gNodeB/gNB, etc.) of a Radio Access Network (RAN) configured to provide cellular communication according to embodiments of inventive concepts. (RAN node 900 may be provided, for example, as discussed below with respect to network node 1360 of FIG. 13.) As shown, the RAN node may include transceiver circuitry 901 (also referred to as a transceiver, e.g., corresponding to portions of interface 1390 of FIG. 13) including a transmitter and a receiver configured to provide uplink and downlink radio communications with mobile terminals. The RAN node may include network interface circuitry 907 (also referred to as a network interface, e.g., corresponding to portions of interface 1390 of FIG. 13) configured to provide communications with other nodes (e.g., with other base stations) of the RAN and/or core network CN. The network node may also include processing circuitry 403 (also referred to as a processor, e.g., corresponding to processing circuitry 1370) coupled to the transceiver circuitry, and memory circuitry 905 (also referred to as memory, e.g., corresponding to device readable medium 1380 of FIG. 13) coupled to the processing circuitry. The memory circuitry 905 may include computer readable program code that when executed by the processing circuitry 903 causes the processing circuitry to perform operations according to embodiments disclosed herein. According to other embodiments, processing circuitry 903 may be defined to include memory so that a separate memory circuitry is not required.

As discussed herein, operations of the RAN node may be performed by processing circuitry 903, network interface 907, and/or transceiver 901. For example, processing circuitry 903 may control transceiver 901 to transmit downlink communications through transceiver 901 over a radio interface to one or more mobile terminals UEs and/or to receive uplink communications through transceiver 901 from one or more mobile terminals UEs over a radio interface. Similarly, processing circuitry 903 may control network interface 907 to transmit communications through network interface 907 to one or more other network nodes and/or to receive communications through network interface from one or more other network nodes. Moreover, modules may be stored in memory 905, and these modules may provide instructions so that when instructions of a module are executed by processing circuitry 903, processing circuitry 903 performs respective operations (e.g., operations discussed below with respect to Example Embodiments relating to RAN nodes). According to some embodiments, RAN node 900 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

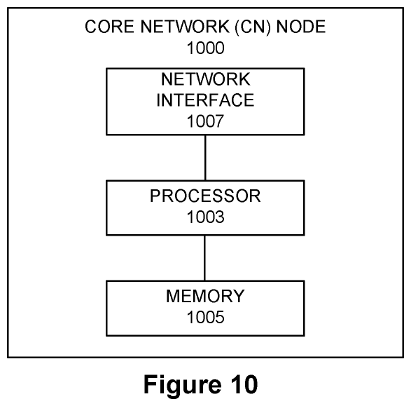

FIG. 10 is a block diagram illustrating elements of a core network CN node (e.g., an SMF node, an AMF node, etc.) of a communication network configured to provide cellular communication according to embodiments of inventive concepts. As shown, the CN node may include network interface circuitry 1007 (also referred to as a network interface) configured to provide communications with other nodes of the core network and/or the radio access network RAN. The CN node may also include a processing circuitry 1003 (also referred to as a processor) coupled to the network interface circuitry, and memory circuitry 505 (also referred to as memory) coupled to the processing circuitry. The memory circuitry 1005 may include computer readable program code that when executed by the processing circuitry 1003 causes the processing circuitry to perform operations according to embodiments disclosed herein. According to other embodiments, processing circuitry 1003 may be defined to include memory so that a separate memory circuitry is not required.

As discussed herein, operations of the CN node may be performed by processing circuitry 1003 and/or network interface circuitry 1007. For example, processing circuitry 1003 may control network interface circuitry 1007 to transmit communications through network interface circuitry 1007 to one or more other network nodes and/or to receive communications through network interface circuitry from one or more other network nodes. Moreover, modules may be stored in memory 1005, and these modules may provide instructions so that when instructions of a module are executed by processing circuitry 1003, processing circuitry 1003 performs respective operations (e.g., operations discussed below with respect to Example Embodiments relating to core network nodes). According to some embodiments, CN node 1000 and/or an element(s)/function(s) thereof may be embodied as a virtual node/nodes and/or a virtual machine/machines.

Prior to describing the various embodiments of inventive concepts, the relevant RRC procedures that may be used with the various embodiments shall be described.

Radio link failure related actions

Detection of physical layer problems in RRC_CONNECTED

The UE shall:
1> if dapsConfig is configured for any DRB, upon receiving N310 consecutive “out-of-sync” indications for the source from lower layers while T304 is running
   2> start timer T310 for the source.
1> upon receiving N310 consecutive “out-of-sync” indications for the SpCell from lower layers while neither T300, T301, T304, T311 nor T319 are running:
   2> start timer T310 for the corresponding SpCell.
Editor's note: TBC on how/whether to capture stop RLM in source after RACH successful to target PCell.
Editor's note: FFS, check whether “source” is suitable for all DAPS related changes, or “source SpCell” should be used in some places, e.g. the timer T310.

Recovery of physical layer problems

Upon receiving N311 consecutive “in-sync” indications for the SpCell from lower layers while T310 is running, the UE shall:
1> stop timer T310 for the corresponding SpCell.
1> stop timer T312 for the corresponding SpCell, if running
NOTE 1: In this case, the UE maintains the RRC connection without explicit signalling, i.e. the UE maintains the entire radio resource configuration.
NOTE 2: Periods in time where neither “in-sync” nor “out-of-sync” is reported by L1 do not affect the evaluation of the number of consecutive “in-sync” or “out-of-sync” indications.

Detection of radio link failure

The UE shall:

1> if dapsConfig is configured for any DRB:
2> upon T310 expiry in source; or
2> upon random access problem indication from source MCG MAC; or
2> upon indication from source MCG RLC that the maximum number of retransmissions has been reached; or
2> upon consistent uplink LBT failure indication from source MCG MAC:
   3> consider radio link failure to be detected for the source MCG i.e. source RLF;
      4> suspend all DRBs in the source;
      4> release the source connection.

1> else:
2> upon T310 expiry in PCell; or
2> upon T312 expiry in PCell; or
2> upon random access problem indication from MCG MAC while neither T300, T301, T304, T311 nor T319 are running; or
2> upon indication from MCG RLC that the maximum number of retransmissions has been reached; or
2> if connected as an IAB-node, upon BH RLF indication received on BAP entity from the MCG; or
2> upon consistent uplink LBT failure indication from MCG MAC while T304 is not running
   3> if the indication is from MCG RLC and CA duplication is configured and activated, and for the corresponding logical channel allowedServingCells only includes SCell(s):
      4> initiate the failure information procedure as specified in 5.7.5 to report RLC failure.
   3> else:
      4> consider radio link failure to be detected for the MCG i.e. RLF;
      4> discard any segments of segmented RRC messages stored according to 5.7.6.3;
      4> store the following radio link failure information in the VarRLF-Report by setting its fields as follows:
         5> clear the information included in VarRLF-Report, if any;
         5> set the plmn-IdentityList to include the list of EPLMNs stored by the UE (i.e. includes the RPLMN);
         5> set the measResultLastServCell to include the RSRP, RSRQ and the available SINR, of the source PCell based on the available SSB and CSI-RS measurements collected up to the moment the UE detected radio link failure;
         5> set the ssbRLMConfigBitmap and/or csi-rsRLMConfigBitmap in measResultLastServCell to include the radio link monitoring configuration of the source PCell;
         5> for each of the configured NR frequencies in which measurements are available:
         6> if the SS/PBCH block-based measurement quantities are available:
         7> set the measResultListNR in measResultNeighCells to include all the available measurement quantities of the best measured cells, other than the source PCell, ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell with highest SS/PBCH block SINR is listed first, based on the available SS/PBCH block based measurements collected up to the moment the UE detected radio link failure;
         8> for each neighbour cell included, include the optional fields that are available;
         6> if the CSI-RS based measurement quantities are available:
         7> set the measResultListNR in measResultNeighCells to include all the available measurement quantities of the best measured cells, other than the source PCell, ordered such that the cell with highest CSI-RS RSRP is listed first if CSI-RS RSRP measurement results are available, otherwise the cell with highest CSI-RS RSRQ is listed first if CSI-RS RSRQ measurement results are available, otherwise the cell with highest CSI-RS SINR is listed first, based on the available CSI-RS based measurements collected up to the moment the UE detected radio link failure;
         8> for each neighbour cell included, include the optional fields that are available;
         5> for each of the configured EUTRA frequencies in which measurements are available:
         6> set the measResultListEUTRA in measResultNeighCells to include the best measured cells ordered such that the cell with highest RSRP is listed first if RSRP measurement results are available, otherwise the cell with highest RSRQ is listed first, and based on measurements collected up to the moment the UE detected radio link failure;
NOTE: The measured quantities are filtered by the L3 filter as configured in the mobility measurement configuration. The measurements are based on the time domain measurement resource restriction, if configured. Blacklisted cells are not required to be reported.
   5> if detailed location information is available, set the content of locationInfo as follows:
      6> if available, set the commonLocationInfo to include the detailed location information;
      6> if available, set the bt-LocationInfo in locationInfo to include the Bluetooth measurement results, in order of decreasing RSSI for Bluetooth beacons;
      6> if available, set the wlan-LocationInfo in locationInfo to include the WLAN measurement results, in order of decreasing RSSI for WLAN APs;
      6> if available, set the sensor-LocationInfo in locationInfo to include the sensor measurement results;
   5> set the failedPCellId to the global cell identity and the tracking area code, if available, and otherwise to the physical cell identity and carrier frequency of the PCell where radio link failure is detected;
   5> if an RRCReconfiguration message including the reconfigurationWithSync was received before the connection failure:
      6> if the last RRCReconfiguration message including the reconfigurationWithSync concerned an intra NR handover:
         7> include the previousPCellId and set it to the global cell identity and the tracking area code of the PCell where the last RRCReconfiguration message including reconfigurationWithSync was received;
         7> set the timeConnFailure to the elapsed time since reception of the last RRCReconfiguration message including the reconfigurationWithSync;
   5> set the connectionFailureType to rlf;
   5> set the c-RNTI to the C-RNTI used in the PCell;
   5> set the rlf-Cause to the trigger for detecting radio link failure;
   5> if the rlf-Cause is set to randomAccessProblem or beamFailureRecoveryFailure:
      6> set the absoluteFrequencyPointA to indicate the absolute frequency of the reference resource block associated to the random-access resources;
      6> set the locationAndBandwidth and subcarrierSpacing associated to the UL BWP of the random-access resources;
      6> set the msg1-FrequencyStart, msg1-FDM and msg1-SubcarrierSpacing associated to the random-access resources;
      6> set the parameters associated to individual random-access attempt in the chronological order of attempts in the perRAInfoList as follows:
         7> if the random-access resource used is associated to a SS/PBCH block, set the associated random-access parameters for the successive random-access attempts associated to the same SS/PBCH block for one or more random-access attempts as follows:
         8> set the ssb-Index to include the SS/PBCH block index associated to the used random-access resource;
         8> set the numberOfPreamblesSentOnSSB to indicate the number of successive random access attempts associated to the SS/PBCH block;
         8> for each random-access attempt performed on the random-access resource, include the following parameters in the chronological order of the random-access attempt:
         9> if contention resolution was not successful as specified in TS 38.321 [6] for the transmitted preamble:
         10> set the contentionDetected to true;
         9> else:
         10> set the contentionDetected to false;
         9> if the SS/PBCH block RSRP of the SS/PBCH block corresponding to the random-access resource used in the random-access attempt is above rsrp-ThresholdSSB:
         10> set the dlRSRPAboveThreshold to true;
         9> else:
         10> set the dlRSRPAboveThreshold to false;
         7> else if the random-access resource used is associated to a CSI-RS, set the associated random-access parameters for the successive random-access attempts associated to the same CSI-RS for one or more radom-access attempts as follows:
         8> set the csi-RS-Index to include the CSI-RS index associated to the used random-access resource;
         8> set the numberOfPreamblesSentOnCSI-RS to indicate the number of successive random-access attempts associated to the CSI-RS;
         8> for each random-access attempt performed on the random-access resource, include the following parameters in the chronological order of the random-access attempt:
         9> if contention resolution was not successful as specified in TS 38.321 [6] for the transmitted preamble:
         10> set the contentionDetected to true;
         9> else:
         10> set the contentionDetected to false;
         9> if the CSI-RS RSRP of the CSI-RS corresponding to the random-access resource used in the random-access attempt is above rsrp-ThresholdCSI-RS:
         10> set the dlRSRPAboveThreshold to true;
         9> else:
         10> set the dlRSRPAboveThreshold to false;
4> if AS security has not been activated:
   5> perform the actions upon going to RRC_IDLE as specified in 5.3.11, with release cause ‘other’;
4> else if AS security has been activated but SRB2 and at least one DRB or, for IAB, SRB2, have not been setup:
   5> perform the actions upon going to RRC_IDLE as specified in 5.3.11, with release cause ‘RRC connection failure’;
4> else:
   5> if T316 is configured; and
   5> if SCG transmission is not suspended; and
   5> if PSCell change is not ongoing (i.e. timer T304 for the NR PSCell is not running in case of NR-DC or timer T307 of the E-UTRA PSCell is not running as specified in TS 36.331 [10], clause 5.3.10.10, in NE-DC):
      6> initiate the MCG failure information procedure as specified in 5.7.3b to report MCG radio link failure.
   5> else:
      6> initiate the connection re-establishment procedure as specified in 5.3.7.

The UE may discard the radio link failure information, i.e. release the UE variable VarRLF-Report, 48 hours after the radio link failure is detected.

The UE shall:
1> upon T310 expiry in PSCell; or
1> upon T312 expiry in PSCell; or
1> upon random access problem indication from SCG MAC; or
1> upon indication from SCG RLC that the maximum number of retransmissions has been reached; or
1> if connected as an IAB-node, upon BH RLF indication received on BAP entity from the SCG; or
1> upon consistent uplink LBT failure indication from SCG MAC:
   2> if the indication is from SCG RLC and CA duplication is configured and activated; and for the corresponding logical channel allowedServingCells only includes SCell(s):
      3> initiate the failure information procedure as specified in 5.7.5 to report RLC failure.
   2> else if MCG transmission is not suspended:
      3> consider radio link failure to be detected for the SCG, i.e. SCG RLF;
      3> initiate the SCG failure information procedure as specified in 5.7.3 to report SCG radio link failure.
   2> else:
      3> if the UE is in NR-DC:
         4> initiate the connection re-establishment procedure as specified in 5.3.7;
      3> else (the UE is in (NG)EN-DC):
         4> initiate the connection re-establishment procedure as specified in TS 36.331 [10], clause 5.3.7.

As previously indicated, different types of failures can happen during DAPS HO. For example, there can be RLF to the source, RLF to the target, or RLF to both. For example, assume the UE receives a DAPS HO command and tries to perform a RA procedure towards the target cell. If this RA procedure fails and the UE declares a RLF in the target cell but tries to come back to source node/cell, but however, the timer T310 with the source has expired and the UE declares RLF on the source cell. Thus, the UE has two RLFs detected, one for the source and another with the target.

Currently, only the handling of RLF in the source is captured in 3GPP.

Various embodiments of inventive concepts provide mechanisms in which a wireless communication device (e.g., a UE) involved in RLF reports the RLF concerning the source cell or/and target cell. The node receiving this RLF report, possibly containing two RLF reports concerning both the source and target cells, will identify if the source and/or target cells do not belong to it, and if so passes the RLF report(s) to the node(s) serving the source and/or target cell(s).

Without various embodiments of the inventive concepts described herein, in case an RLF happens during DAPS HO on the source, target or both, important information typical of the RLF report are not sent to the network after re-establishing the connectivity with a new cell/node (or reverting back to the source), and this may lead to sub-optimal network decisions/configuration/operation.

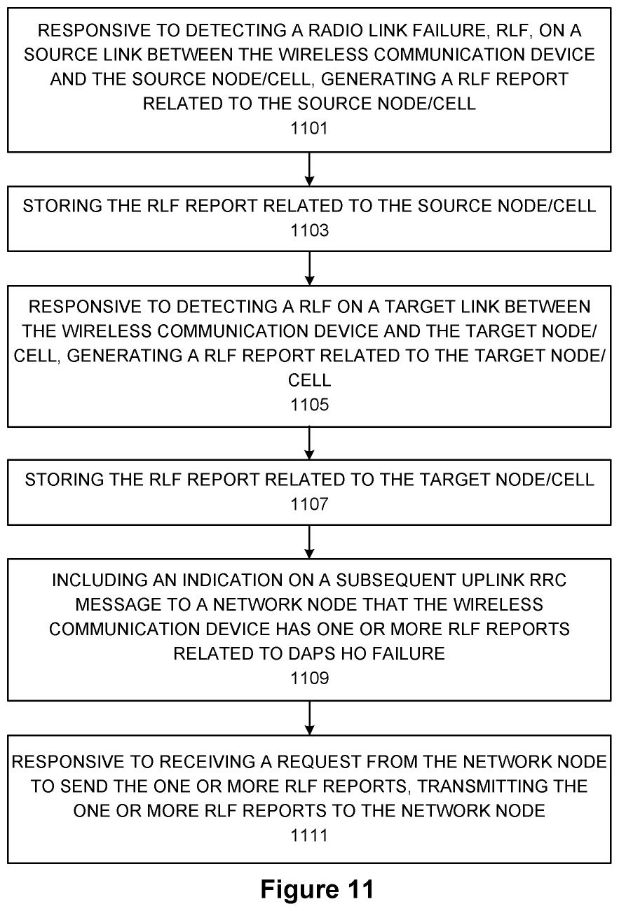

Operations from the perspective of the wireless communication device 800 (implemented using the structure of the block diagram of FIG. 8) will now be discussed with reference to the flow chart of FIG. 11 according to some embodiments of inventive concepts. For example, modules may be stored in memory 805 of FIG. 3, and these modules may provide instructions so that when the instructions of a module are executed by respective communication device processing circuitry 803, processing circuitry 803 performs respective operations of the flow chart.

Turning to FIG. 11, a method at a wireless communication device (e.g., user Equipment—UE), capable of performing a Dual Active Protocol Stack (DAPS) handover, from a source node/cell to a target node/cell, where the source and target nodes could be the same or different is illustrated.

In block 1101, the processing circuitry 803, responsive to detecting a radio link failure, RLF, on a source link between the wireless communication device and the source node/cell, generates a RLF report related to the source node/cell. In block 1103, the processing circuitry 803 stores the RLF report related to the source node/cell.

In block 1105, the processing circuitry 803, responsive to detecting a radio link failure, RLF, on a target link between the wireless communication device and the target node/cell, generates a RLF report related to the target node/cell. In block 1107, the processing circuitry 803 stores the RLF report related to the target node/cell.

Storing the RLF reports in some embodiments includes storing each RLF report in the same RLF report information element. For example, the RLF-Report can be enhanced to contain both reports as indicated by the bold and underlined text, while the UE variable contains only one entry, as shown below, e.g.

| RLF-Report-r16 ::= | CHOICE { | |
|---|---|---|
| nr-RLF-Report-r16 | SEQUENCE { | |
| measResultLastServCell-r16 | MeasResultRLFNR-r16, | |
| measResultNeighCells-r16 | SEQUENCE { | |
| measResultListNR-r16 | MeasResultList2NR-r16 | OPTIONAL, |
| measResultListEUTRA-r16 | MeasResultList2EUTRA-r16 OPTIONAL | |
| } | OPTIONAL, | |
| c-RNTI-r16 | RNTI-Value, | |
| previousPCellId-r16 | CGI-Info-LoggingDetailed-r16 | OPTIONAL, |
| failedPCellId-r16 | CHOICE { | |
| cellGlobalId-r16 | CGI-Info-LoggingDetailed-r16 | |
| pci-arfcn-r16 | SEQUENCE { | |
| physCellId-r16 | PhysCellId, | |
| carrierFreq-r16 | ARFCN-ValueNR | |
| } | | |
| } | OPTIONAL, | |
| reestablishmentCellId-r16 | CGI-Info-Logging-r16 | OPTIONAL, |
| timeConnFailure-r16 | INTEGER (0..1023) | OPTIONAL, |
| timeSinceFailure-r16 | TimeSinceFailure-r16, | |
| connectionFailureType-r16 | ENUMERATED {rlf, hof} | OPTIONAL, |
| rlf-Cause-r16 | ENUMERATED {t310-Expiry, randomAccessProblem, | |
| rlc-MaxNumRetx, | | |
| | beamFailureRecoveryFailure, bh-rlfRecoveryFailure, | |
| spare3, spare2, spare1}, | | |
| locationInfo-r16 | LocationInfo-r16 | OPTIONAL, |
| absoluteFrequencyPointA-r16 | ARFCN-ValueNR | OPTIONAL, |
| locationAndBandwidth-r16 | INTEGER (0..37949) | OPTIONAL, |
| subcarrierSpacing-r16 | SubcarrierSpacing | OPTIONAL, |
| msg1-FrequencyStart-r16 | INTEGER (0..maxNrofPhysicalResourceBlocks-1) | |
| OPTIONAL, | | |
| msg1-SubcarrierSpacing-r16 | SubcarrierSpacing | OPTIONAL, |
| msg1-FDM-r16 | ENUMERATED {one, two, four, eight} OPTIONAL, | |
| perRAInfoList-r16 | PerRAInfoList-r16 | OPTIONAL, |
| noSuitableCellFound-r16 | ENUMERATED {true} | OPTIONAL |
| }, | | |
| eutra-RLF-Report-r16 | SEQUENCE { | |
| failedPCellId-EUTRA | CGI-InfoEUTRALogging, | |
| measResult-RLF-Report-EUTRA-r16 | OCTET STRING | |

```
  }
}
RLF-Report-r17:: = SEQUENCE {
  source-rlf-r17 RLF-Report-r16 OPTIONAL,
    target-rlf-r17 RLF-Report-r16 OPTIONAL
}
VarRLF-Report-r17 ::= SEQUENCE {
  rlf-Report-r17 RLF-Report-r17,
  plmn-IdentityList-r16 PLMNIdentityList-r16
}
```

Storing the RLF reports in some other embodiments includes storing each RLF report in a RLF report information element such that each RLF report information element contains only one RLF report. Thus, the RLF reports are stored separately and no additional information elements are used. For example, in one embodiment, the wireless communication device 800 may store the RLF reports as shown below:

```
VarRLF-Report-r16 ::= SEQUENCE {
  rlf-Report-r16 ,
  plmn-IdentityList-r16
}
VarRLF-Report-r17::= SEQUENCE {
  source-rlf-r17 SEQUENCE
                                          {
                                                rlf-report-r17
        RLF-Report-r16,
                                            plmn-IdentityList-r17
PLMN-IdentityList-r16
                                          }
  target-rlf-r17 SEQUENCE
                                          {
                                                rlf-report-r17
        RLF-Report-r16,
                                            plmn-IdentityList-r17
PLMN-IdentityList-r16
                                          }
}
```

In block 1109, the processing circuitry 803 includes an indication on a subsequent uplink radio resource control, RRC, message to a network node that the wireless communication device has one or more RLF reports related to DAPS HO failure. For example, the RRC message may be a RRCReconfigurationComplete message, a RRCResumeComplete message, a RRCSetupComplete message, a RRCReestablishmentComplete message, a UEAssistanceInformation message, etc. The indication that the one or more RLF reports are related to DAPS HO failure in one embodiment is included in a RLF cause value (e.g. modifying/extending the rlf-Cause IE in the RLF-Report IE). In another embodiment, the indication that the one or more RLF reports are related to DAPS HO failure is provided in an information element for indicating DAP HO failure (i.e. a Boolean flag that indicates whether this RLF report is related to DAPs HO, and the legacy rlf-Cause IE used to indicate the reason for the failure, such as t310-expiry, RA problem, etc.).

The network node could be the node serving the source cell, or a node serving the target cell, or a node serving both the source cell and the target cell, or a node serving neither the source nor the target cell.

In block 1111, the processing circuitry 803, responsive to receiving a request from the network node to send the one or more RLF reports, transmits the one or more RLF reports to the network node. The request may be a UEInformationRequest. The response may then be transmitted using a UEInformationResponse message.

Various operations from the flow chart of FIG. 11 may be optional with respect to some embodiments of communication devices and related methods. Regarding methods of example embodiment 1 (set forth below), for example, operations of blocks 1103 and 1105 of FIG. 11 may be optional.

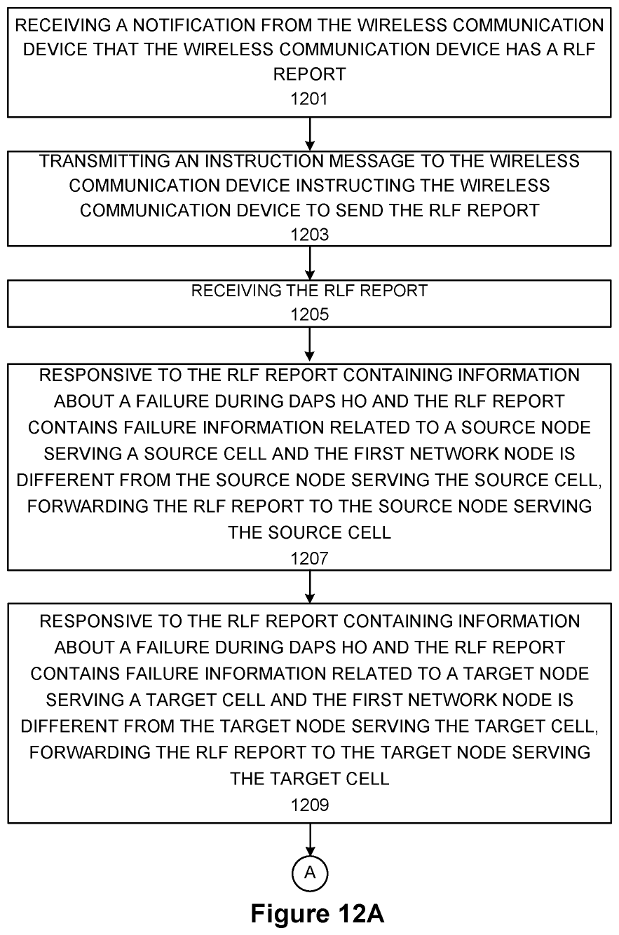

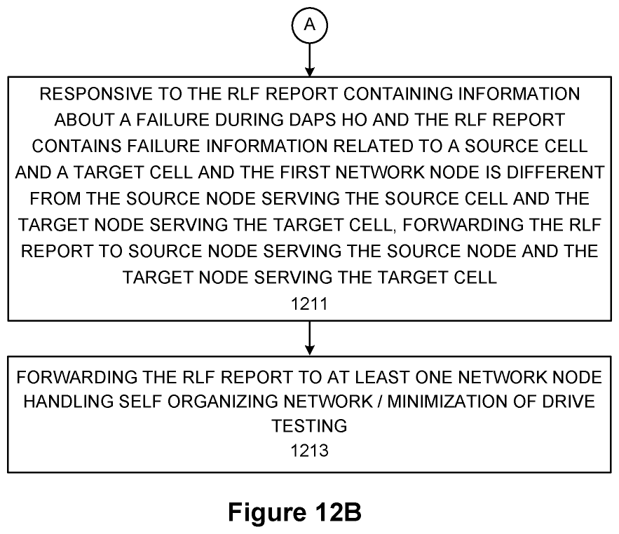

Operations from the perspective of a first network node 900 (implemented using the structure of FIG. 9) providing connectivity to a wireless communication device will now be discussed with reference to the flow chart of FIGS. 12A and 12B. according to some embodiments of inventive concepts. For example, modules may be stored in memory 905 of FIG. 9, and these modules may provide instructions so that when the instructions of a module are executed by respective network node processing circuitry 903, processing circuitry 903 performs respective operations of the flow chart.

Turing to FIG. 12A, in block 1201, the processing circuitry 903 receives, via transceiver circuitry 901 and/or network interface circuitry 907, a notification from the wireless communication device that the wireless communication device has a radio link failure, RLF, report. The notification may be the indication as described above.

In block 1203, the processing circuitry 903 transmits, via the transceiver circuitry 901 and/or the network interface circuitry 907, an instruction message to the wireless communication device instructing the wireless communication device to send the RLF report. The request be sent in a UEInformationRequest message.

In block 1205, the processing circuitry 903 receives, via the transceiver circuitry 901 and/or the network interface circuitry 907, the RLF report. The RLF report may be a plurality of RLF reports in a single information element or multiple information elements as described above.

In block 1207, the processing circuitry 903, responsive to the RLF report containing information about a failure during dual active protocol stack handover (DAPS HO) and the RLF report contains failure information related to a source node serving a source cell and the first network node is different from the source node serving the source cell, forwards, via transceiver circuitry 901 and/or network interface circuitry 907, the RLF report to the source node serving the source cell.

In some embodiments, forwarding the RLF report to the source node serving the source cell includes forwarding the RLF report to the source node serving the source cell via X2/Xn message/signaling. In other embodiments, forwarding the RLF report to the source node serving the source cell comprises forwarding the RLF report to the source node serving the source cell via inter-node radio resource control, RRC, messages.

In further embodiments, responsive to the source node employing a centralized unit/distributed unit, CU/DU, split architecture, forwarding the RLF report including forwarding the RLF report to the CU of the source node. The CU can further forward (either all, or parts of the info from the RLF) to the DU that is serving the source cell indicated in the RLF report. In further embodiments, transmitting the RLF report to the source node includes transmitting the RLF report to the source node via a core network function/node. The core network function/node may be an access and mobility management function (AMF) function/node (e.g. via the NG interface, where the first network node sends the message to the AMF, and the AMF forwards the message to the source node serving the source cell).

In block 1209, the processing circuitry 903, responsive to the RLF report containing information about a failure during dual active protocol stack handover (DAPS HO) and the RLF report contains failure information related to a target node serving a target cell and the first network node is different from the target node serving the target cell, forwards, via transceiver circuitry 901 and/or network interface circuitry 907, the RLF report to the target node serving the target cell.

In some embodiments, forwarding the RLF report to the target node serving the target cell includes forwarding the RLF report to the target node serving the target cell via X2/Xn message/signaling. In other embodiments, forwarding the RLF report to the target node serving the target cell comprises forwarding the RLF report to the target node serving the target cell via inter-node radio resource control, RRC, messages.

In further embodiments, responsive to the target node employing a centralized unit/distributed unit, CU/DU, split architecture, forwarding the RLF report including forwarding the RLF report to the CU of the target node. The CU can further forward (either all, or parts of the info from the RLF) to the DU that is serving the target cell indicated in the RLF report. In further embodiments, transmitting the RLF report to the target node includes transmitting the RLF report to the target node via a core network function/node. The core network function/node may be an access and mobility management function (AMF) function/node (e.g. via the NG interface, where the first network node sends the message to the AMF, and the AMF forwards the message to the target node serving the target cell).

Turing to FIG. 12B, in block 1211, the processing circuitry 903, responsive to the RLF report containing information about a failure during dual active protocol stack handover (DAPS HO) and the RLF report contains failure information related to a source cell and a target cell and the first network node is different from the source node serving the source cell and from the target node serving the target cell, forwards, via the transceiver circuitry 901 and/or network interface circuitry 907, the RLF report to the source node serving the source cell and the target node serving the target cell.

In block 1213, the processing circuitry 903 forwards the RLF report to at least one network node handling self organizing network/minimization of drive testing, SON/MDT, in the wireless network.

Various operations from the flow chart of FIGS. 12A and 12B may be optional with respect to some embodiments of first network nodes and related methods. Regarding methods of example embodiment 19 (set forth below), for example, operations of block 1213 of FIGS. 12A and 12B may be optional.

Thus, in case an RLF happens during DAPS HO on the source, target or both, important information typical of the RLF report are sent to the network after re-establishing the connectivity with a new cell/node (or reverting back to the source), and this may lead to more optimal network decisions/configuration/operations.

Example embodiments are discussed below.

Embodiment 1. A method performed by a wireless communication device, enabled to perform a Dual Active Protocol Stack (DAPS) handover, HO, from a source node/cell to a target node/cell, the method comprising:

responsive to detecting a radio link failure, RLF, on a source link between the wireless communication device and the source node/cell, generating (1101) a RLF report related to the source node/cell;

responsive to detecting a RLF on a target link between the wireless communication device and the target node/cell, generating (1105) a RLF report related to the target node/cell;

including (1109) an indication on a subsequent uplink radio resource control, RRC, message to a network node that the wireless communication device has one or more RLF reports related to DAPS HO failure;

responsive to receiving a request from the network node to send the one or more RLF reports, transmitting (1111) the one or more RLF reports to the network node.

Embodiment 2. The method of Embodiment 1, further comprising storing (1103) the RLF report related to the source node/cell.
Embodiment 3. The method of any of Embodiments 1-2, further comprising storing (1107) the RLF report related to the target node/cell.
Embodiment 4. The method of any of Embodiments 2-3 wherein storing (1103, 1107) the RLF report comprises storing each RLF report with a same RLF report information element.
Embodiment 5. The method of any of Embodiments 2-3 wherein storing (1103, 1107) the RLF report comprises storing each RLF report in a RLF report information element such that each RLF report information element contains only one RLF report.
Embodiment 6. The method of any of Embodiments 1-5 wherein the indication that the one or more RLF reports are related to DAPS HO failure is included in a RLF cause value.
Embodiment 7. The method of any of Embodiments 1-5 wherein the indication that the one or more RLF reports are related to DAPS HO failure is provided in an information element for indicating DAP HO failure.
Embodiment 8. A wireless communication device (800) adapted to perform operations comprising:

responsive to detecting a radio link failure, RLF, on a source link between the wireless communication device and a source node/cell, generating (1101) a RLF report related to the source node/cell;

responsive to detecting a RLF on a target link between the wireless communication device and a target node/cell, generating (1105) a RLF report related to the target node/cell;

including (1109) an indication on a subsequent uplink radio resource control, RRC, message to a network node that the wireless communication device has one or more RLF reports related to DAPS HO failure;

responsive to receiving a request from the network node to send the one or more RLF reports, transmitting (1111) the one or more RLF reports to the network node.

Embodiment 9. The wireless communication device (800) of Embodiment 8 wherein the wireless communication device is adapted to perform operations according to any of Embodiments 2-7.
Embodiment 10. A wireless communication device (800) comprising:

processing circuitry (803); and

memory (805) coupled with the processing circuitry, wherein the memory includes instructions that when executed by the processing circuitry causes the wireless communication device to perform operations comprising:
responsive to detecting a radio link failure, RLF, on a source link between the wireless communication device and a source node/cell, generating (1101) a RLF report related to the source node/cell;
responsive to detecting a RLF on a target link between the wireless communication device and a target node/cell, generating (1105) a RLF report related to the target node/cell;
including (1109) an indication on a subsequent uplink radio resource control, RRC, message to a network node that the wireless communication device has one or more RLF reports related to DAPS HO failure;
responsive to receiving a request from the network node to send the one or more RLF reports, transmitting (1111) the one or more RLF reports to the network node.
   Embodiment 11. The wireless communication device (800) of Embodiment 10, wherein the memory includes further instructions that when executed by the processing circuitry causes the wireless communication device to perform operations further comprising storing (1103) the RLF report related to the source node/cell.
   Embodiment 12. The wireless communication device (800) of any of Embodiments 10-11, wherein the memory includes further instructions that when executed by the processing circuitry causes the wireless communication device to perform operations further comprising storing (1107) the RLF report related to the target node/cell.
   Embodiment 13. The wireless communication device (800) of any of Embodiments 11-12 wherein in storing (1103, 1107) the RLF report, the memory includes instructions that when executed by the processing circuitry causes the wireless communication device to perform operations comprising storing each RLF report with a same RLF report information element.
   Embodiment 14. The wireless communication device (800) of any of Embodiments 11-12 wherein in storing (1103, 1107) the RLF report, the memory includes instructions that when executed by the processing circuitry causes the wireless communication device to perform operations comprising storing each RLF report in a RLF report information element such that each RLF report information element contains only one RLF report.
   Embodiment 15. The wireless communication device (800) of any of Embodiments 10-14 wherein the indication that the one or more RLF reports are related to DAPS HO failure is included in a RLF cause value.
   Embodiment 16. The wireless communication device (800) of any of Embodiments 10-14 wherein the indication that the one or more RLF reports are related to DAPS HO failure is provided in an information element for indicating DAP HO failure.
   Embodiment 17. A computer program comprising program code to be executed by processing circuitry (803) of a wireless communication device (800), whereby execution of the program code causes the wireless communication device (800) to perform operations according to any of embodiments 1-7.
   Embodiment 18. A computer program product comprising a non-transitory storage medium including program code to be executed by processing circuitry (803) of a wireless communication device (800), whereby execution of the program code causes the wireless communication device (800) to perform operations according to any of embodiments 1-7.
   Embodiment 19. A method performed by a first network node providing connectivity to a wireless communication device in a wireless network, the method comprising:

receiving (1201) a notification from the wireless communication device that the wireless communication device has a radio link failure, RLF, report;

transmitting (1203) an instruction message to the wireless communication device instructing the wireless communication device to send the RLF report;

receiving (1205) the RLF report;

responsive to the RLF report containing information about a failure during dual active protocol stack handover, DAPS HO, and the RLF report contains failure information related to a source node serving a source cell and the first network node is different from the source node serving the source cell, forwarding (1207) the RLF report to the source node serving the source cell;

responsive to the RLF report containing information about a failure during DAPS HO and the RLF report contains failure information related to a target node serving a target cell and the first network node is different from the target node serving the target cell, forwarding (1209) the RLF report to the target node serving the target cell; and

responsive to the RLF report containing information about a failure during DAPS HO and the RLF report contains failure information related to a source cell and a target cell and the first network node is different from the source node serving the source cell and from the target node serving the target cell, forwarding (1211) the RLF report to the source node serving the source cell and the target node serving the target cell.

Embodiment 20. The method of Embodiment 19, further comprising forwarding (1213) the RLF report to at least one network node handling self organizing network/minimization of drive testing, SON/MDT, in the wireless network.
Embodiment 21. The method of any of Embodiments 19-20 wherein forwarding the RLF report to the source node serving the source cell comprises forwarding the RLF report to the source node serving the source cell via X2/Xn message/signaling.
Embodiment 22. The method of any of Embodiments 19-20 wherein forwarding the RLF report to the target node serving the target cell comprises forwarding the RLF report to the target node serving the target cell via X2/Xn message/signaling.
Embodiment 23. The method of any of Embodiments 19-20 wherein forwarding the RLF report to the source node serving the source cell comprises forwarding the RLF report to the source node serving the source cell via inter-node radio resource control, RRC, messages.
Embodiment 24. The method of any of Embodiments 19-20, wherein forwarding the RLF report to the target node serving the target cell comprises forwarding the RLF report to the target node serving the target cell via inter-node radio resource control, RRC, messages.
Embodiment 25. The method of Embodiment 19-20, wherein responsive to at least one of the source node and the target node employing a centralized unit/distributed unit, CU/DU, split architecture, forwarding the RLF report comprises forwarding the RLF report to the CU of the at least one of the source node and the target node.
Embodiment 26. The method of any of Embodiments 19-20, wherein transmitting the RLF report to the source node and transmitting the RLF report to the target node comprises transmitting the RLF report to the source node via a core network function/node and transmitting the RLF report to the target node via the core network function/node.
Embodiment 27. The method of Embodiment 26 wherein the core network function/node comprises an access and mobility management function, AMF, function/node.
Embodiment 28. A first network node (900) in a wireless network, the first network node (900) adapted to perform operations comprising:

receiving (1201) a notification from a wireless communication device that the wireless communication device has a radio link failure, RLF, report;

transmitting (1203) an instruction message to the wireless communication device instructing the wireless communication device to send the RLF report;

receiving (1205) the RLF report;

responsive to the RLF report containing information about a failure during dual active protocol stack handover, DAPS HO, and the RLF report contains failure information related to a source node serving a source cell and the first network node is different from the source node serving the source cell, forwarding (1207) the RLF report to the source node serving the source cell;

responsive to the RLF report containing information about a failure during DAPS HO and the RLF report contains failure information related to a target node serving a target cell and the first network node is different from the target node serving the target cell, forwarding (1209) the RLF report to the target node serving the target cell; and

responsive to the RLF report containing information about a failure during DAPS HO and the RLF report contains failure information related to a source cell and a target cell and the first network node is different from the source node serving the source cell and from the target node serving the target cell, forwarding (1211) the RLF report to the source node serving the source cell and the target node serving the target cell.

Embodiment 29. The first network node (900) of Embodiment 28, wherein the first network node (900) is further adapted to perform operations according to any of Embodiments 20-27.
Embodiment 30. A first network node (900) in a wireless network, the first network node (900) comprising:

processing circuitry (903); and

memory (905) coupled with the processing circuitry, wherein the memory includes instructions that when executed by the processing circuitry causes the first network node to perform operations comprising:
receiving (1201) a notification from a wireless communication device that the wireless communication device has a radio link failure, RLF, report;
transmitting (1203) an instruction message to the wireless communication device instructing the wireless communication device to send the RLF report;
receiving (1205) the RLF report;
responsive to the RLF report containing information about a failure during dual active protocol stack handover, DAPS HO, and the RLF report contains failure information related to a source node serving a source cell and the first network node is different from the source node serving the source cell, forwarding (1207) the RLF report to the source node serving the source cell;
responsive to the RLF report containing information about a failure during DAPS HO and the RLF report contains failure information related to a target node serving a target cell and the first network node is different from the target node serving the target cell, forwarding (1209) the RLF report to the target node serving the target cell; and
responsive to the RLF report containing information about a failure during DAPS HO and the RLF report contains failure information related to a source cell and a target cell and the first network node is different from the source node serving the source cell and from the target node serving the target cell, forwarding (1211) the RLF report to the source node serving the source cell and the target node serving the target cell.
   Embodiment 31. The first network node (900) of Embodiment 30, wherein the memory includes further instructions that when executed by the processing circuitry causes the first network node to perform operations further comprising forwarding (1213) the RLF report to at least one network node handling self organizing network/minimization of drive testing, SON/MDT, in the wireless network.
   Embodiment 32. The first network node (900) of any of Embodiments 30-31 wherein in forwarding the RLF report to the source node serving the source cell, the memory includes instructions that when executed by the processing circuitry causes the first network node to perform operations comprising forwarding the RLF report to the source node serving the source cell via X2/Xn message/signaling.
   Embodiment 33. The first network node (900) of any of Embodiments 30-31 wherein in forwarding the RLF report to the target node serving the target cell, the memory includes instructions that when executed by the processing circuitry causes the first network node to perform operations comprising forwarding the RLF report to the target node serving the target cell via X2/Xn message/signaling.
   Embodiment 34. The first network node (900) of any of Embodiments 30-31 wherein in forwarding the RLF report to the source node serving the source cell, the memory includes instructions that when executed by the processing circuitry causes the first network node to perform operations comprising forwarding the RLF report to the source node serving the source cell via inter-node radio resource control, RRC, messages.
   Embodiment 35. The first network node (900) of any of Embodiments 30-31, wherein in forwarding the RLF report to the target node serving the target cell, the memory includes instructions that when executed by the processing circuitry causes the first network node to perform operations comprising forwarding the RLF report to the target node serving the target cell via inter-node radio resource control, RRC, messages.
   Embodiment 36. The first network node (900) of Embodiment 30-31, wherein responsive to at least one of the source node and the target node employing a centralized unit/distributed unit, CU/DU, split architecture, in forwarding the RLF report, the memory includes instructions that when executed by the processing circuitry causes the first network node to perform operations comprising forwarding the RLF report to the CU of the at least one of the source node and the target node.
   Embodiment 37. The first network node (900) of any of Embodiments 30-31, wherein in transmitting the RLF report to the source node and in transmitting the RLF report to the target node, the memory includes instructions that when executed by the processing circuitry causes the first network node to perform operations comprising transmitting the RLF report to the source node via a core network function/node and transmitting the RLF report to the target node via the core network function/node.
   Embodiment 38. The first network node (900) of Embodiment 26 wherein the core network function/node comprises an access and mobility management function, AMF, function/node.
   Embodiment 39. A computer program comprising program code to be executed by processing circuitry (903) of a first network node (900), whereby execution of the program code causes the first network node (900) to perform operations according to any of embodiments 19-27.
   Embodiment 40. A computer program product comprising a non-transitory storage medium including program code to be executed by processing circuitry (903) of a first network node (900), whereby execution of the program code causes the first network node (900) to perform operations according to any of embodiments 19-27.

Explanations are provided below for various abbreviations/acronyms used in the present disclosure.

| Abbreviation | Explanation |
|---|---|
| ACK | Acknowledgement |
| AP | Application Protocol |
| BH | Backhaul |
| BSR | Buffer Status Report |
| BWP | Bandwidth Part |
| C-RNTI | Cell Radio Network Temporary Identifier |
| CA | Carrier Aggregation |
| CE | Control Element |
| CP | Control Plane |
| CQI | Channel Quality Indicator |
| DC | Dual Connectivity |
| DCI | Downlink Control Information |
| DL | Downlink |
| DRB | Data Radio Bearer |
| eNB | (EUTRAN) base station |
| E-RAB | EUTRAN Radio Access Bearer |
| FDD | Frequency Division Duplex |
| gNB | NR base station |
| GTP-U | GPRS Tunneling Protocol-User Plane |
| IP | Internet Protocol |
| LTE | Long Term Evolution |
| MCG | Master Cell Group |
| MAC | Medium Access Control |
| MeNB | Master eNB |
| MgNB | Master gNB |
| MN | Master Node |
| NACK | Negative Acknowledgement |
| NR | New Radio |
| PDCP | Packet Data Convergence Protocol |
| PCell | Primary Cell |
| PCI | Physical Cell Identity |
| PSCell | Primary SCell |
| PUSCH | Phyical Uplink Shared Channel |
| RLC | Radio Link Control |
| RLF | Radio Link Failure |
| RRC | Radio Resource Control |
| SCell | Secondary Cell |
| SCG | Secondary Cell Group |
| SCTP | Stream Control Transmission Protocol |
| SeNB | Secondary eNB |
| SINR | Signal to Interference plus Noise Ratio |
| SN | Secondary Node |
| SR | Scheduling Request |
| SRB | Signaling Radio Bearer |
| SUL | Supplementary uplink |
| TDD | Time Division Duplex |
| TEID | Tunnel Endpoint IDentifier |
| TNL | Transport Network Layer |
| UCI | Uplink Control Information |
| UDP | User Datagram Protocol |
| UE | User Equipment |
| UL | Uplink |
| UP | User Plane |
| URLLC | Ultra Reliable Low Latency Communication |
| X2 | Interface between base stations |

References are identified below.

*****Insert Full Citations of References Mentioned in IvD*****

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 13 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 1306, network nodes 1360 and 1360b, and WDs 1310, 1310b, and 1310c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 1360 and wireless device (WD) 1310 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1360 and WD 1310 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 1360 includes processing circuitry 1370, device readable medium 1380, interface 1390, auxiliary equipment 1384, power source 1386, power circuitry 1387, and antenna 1362. Although network node 1360 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1360 are depicted as single boxes located within a larger box, or nested within multiple boxes, in practice, a network node may comprise multiple different physical components that make up a single illustrated component (e.g., device readable medium 1380 may comprise multiple separate hard drives as well as multiple RAM modules).

Similarly, network node 1360 may be composed of multiple physically separate components (e.g., a NodeB component and a RNC component, or a BTS component and a BSC component, etc.), which may each have their own respective components. In certain scenarios in which network node 1360 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1360 may be configured to support multiple radio access technologies (RATs). In such embodiments, some components may be duplicated (e.g., separate device readable medium 1380 for the different RATs) and some components may be reused (e.g., the same antenna 1362 may be shared by the RATs). Network node 1360 may also include multiple sets of the various illustrated components for different wireless technologies integrated into network node 1360, such as, for example, GSM, WCDMA, LTE, NR, WiFi, or Bluetooth wireless technologies. These wireless technologies may be integrated into the same or different chip or set of chips and other components within network node 1360.

Processing circuitry 1370 is configured to perform any determining, calculating, or similar operations (e.g., certain obtaining operations) described herein as being provided by a network node. These operations performed by processing circuitry 1370 may include processing information obtained by processing circuitry 1370 by, for example, converting the obtained information into other information, comparing the obtained information or converted information to information stored in the network node, and/or performing one or more operations based on the obtained information or converted information, and as a result of said processing making a determination.

Processing circuitry 1370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1360 components, such as device readable medium 1380, network node 1360 functionality. For example, processing circuitry 1370 may execute instructions stored in device readable medium 1380 or in memory within processing circuitry 1370. Such functionality may include providing any of the various wireless features, functions, or benefits discussed herein. In some embodiments, processing circuitry 1370 may include a system on a chip (SOC).

In some embodiments, processing circuitry 1370 may include one or more of radio frequency (RF) transceiver circuitry 1372 and baseband processing circuitry 1374. In some embodiments, radio frequency (RF) transceiver circuitry 1372 and baseband processing circuitry 1374 may be on separate chips (or sets of chips), boards, or units, such as radio units and digital units. In alternative embodiments, part or all of RF transceiver circuitry 1372 and baseband processing circuitry 1374 may be on the same chip or set of chips, boards, or units

In certain embodiments, some or all of the functionality described herein as being provided by a network node, base station, eNB or other such network device may be performed by processing circuitry 1370 executing instructions stored on device readable medium 1380 or memory within processing circuitry 1370. In alternative embodiments, some or all of the functionality may be provided by processing circuitry 1370 without executing instructions stored on a separate or discrete device readable medium, such as in a hard-wired manner In any of those embodiments, whether executing instructions stored on a device readable storage medium or not, processing circuitry 1370 can be configured to perform the described functionality. The benefits provided by such functionality are not limited to processing circuitry 1370 alone or to other components of network node 1360, but are enjoyed by network node 1360 as a whole, and/or by end users and the wireless network generally.

Device readable medium 1380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1370. Device readable medium 1380 may store any suitable instructions, data or information, including a computer program, software, an application including one or more of logic, rules, code, tables, etc. and/or other instructions capable of being executed by processing circuitry 1370 and, utilized by network node 1360. Device readable medium 1380 may be used to store any calculations made by processing circuitry 1370 and/or any data received via interface 1390. In some embodiments, processing circuitry 1370 and device readable medium 1380 may be considered to be integrated.

Interface 1390 is used in the wired or wireless communication of signalling and/or data between network node 1360, network 1306, and/or WDs 1310. As illustrated, interface 1390 comprises port(s)/terminal(s) 1394 to send and receive data, for example to and from network 1306 over a wired connection. Interface 1390 also includes radio front end circuitry 1392 that may be coupled to, or in certain embodiments a part of, antenna 1362. Radio front end circuitry 1392 comprises filters 1398 and amplifiers 1396. Radio front end circuitry 1392 may be connected to antenna 1362 and processing circuitry 1370. Radio front end circuitry may be configured to condition signals communicated between antenna 1362 and processing circuitry 1370. Radio front end circuitry 1392 may receive digital data that is to be sent out to other network nodes or WDs via a wireless connection. Radio front end circuitry 1392 may convert the digital data into a radio signal having the appropriate channel and bandwidth parameters using a combination of filters 1398 and/or amplifiers 1396. The radio signal may then be transmitted via antenna 1362. Similarly, when receiving data, antenna 1362 may collect radio signals which are then converted into digital data by radio front end circuitry 1392. The digital data may be passed to processing circuitry 1370. In other embodiments, the interface may comprise different components and/or different combinations of components.

In certain alternative embodiments, network node 1360 may not include separate radio front end circuitry 1392, instead, processing circuitry 1370 may comprise radio front end circuitry and may be connected to antenna 1362 without separate radio front end circuitry 1392. Similarly, in some embodiments, all or some of RF transceiver circuitry 1372 may be considered a part of interface 1390. In still other embodiments, interface 1390 may include one or more ports or terminals 1394, radio front end circuitry 1392, and RF transceiver circuitry 1372, as part of a radio unit (not shown), and interface 1390 may communicate with baseband processing circuitry 1374, which is part of a digital unit (not shown).

Antenna 1362 may include one or more antennas, or antenna arrays, configured to send and/or receive wireless signals. Antenna 1362 may be coupled to radio front end circuitry 1392 and may be any type of antenna capable of transmitting and receiving data and/or signals wirelessly. In some embodiments, antenna 1362 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1362 may be separate from network node 1360 and may be connectable to network node 1360 through an interface or port.

Antenna 1362, interface 1390, and/or processing circuitry 1370 may be configured to perform any receiving operations and/or certain obtaining operations described herein as being performed by a network node. Any information, data and/or signals may be received from a wireless device, another network node and/or any other network equipment. Similarly, antenna 1362, interface 1390, and/or processing circuitry 1370 may be configured to perform any transmitting operations described herein as being performed by a network node. Any information, data and/or signals may be transmitted to a wireless device, another network node and/or any other network equipment.

Power circuitry 1387 may comprise, or be coupled to, power management circuitry and is configured to supply the components of network node 1360 with power for performing the functionality described herein. Power circuitry 1387 may receive power from power source 1386. Power source 1386 and/or power circuitry 1387 may be configured to provide power to the various components of network node 1360 in a form suitable for the respective components (e.g., at a voltage and current level needed for each respective component). Power source 1386 may either be included in, or external to, power circuitry 1387 and/or network node 1360. For example, network node 1360 may be connectable to an external power source (e.g., an electricity outlet) via an input circuitry or interface such as an electrical cable, whereby the external power source supplies power to power circuitry 1387. As a further example, power source 1386 may comprise a source of power in the form of a battery or battery pack which is connected to, or integrated in, power circuitry 1387. The battery may provide backup power should the external power source fail. Other types of power sources, such as photovoltaic devices, may also be used.

Alternative embodiments of network node 1360 may include additional components beyond those shown in FIG. 13 that may be responsible for providing certain aspects of the network node's functionality, including any of the functionality described herein and/or any functionality necessary to support the subject matter described herein. For example, network node 1360 may include user interface equipment to allow input of information into network node 1360 and to allow output of information from network node 1360. This may allow a user to perform diagnostic, maintenance, repair, and other administrative functions for network node 1360.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1310 includes antenna 1311, interface 1314, processing circuitry 1320, device readable medium 1330, user interface equipment 1332, auxiliary equipment 1334, power source 1336 and power circuitry 1337. WD 1310 may include multiple sets of one or more of the illustrated components for different wireless technologies supported by WD 1310, such as, for example, GSM, WCDMA, LTE, NR, WiFi, WiMAX, or Bluetooth wireless technologies, just to mention a few. These wireless technologies may be integrated into the same or different chips or set of chips as other components within WD 1310.

Antenna 1311 may include one or more antennas or antenna arrays, configured to send and/or receive wireless signals, and is connected to interface 1314. In certain alternative embodiments, antenna 1311 may be separate from WD 1310 and be connectable to WD 1310 through an interface or port. Antenna 1311, interface 1314, and/or processing circuitry 1320 may be configured to perform any receiving or transmitting operations described herein as being performed by a WD. Any information, data and/or signals may be received from a network node and/or another WD. In some embodiments, radio front end circuitry and/or antenna 1311 may be considered an interface.

As illustrated, interface 1314 comprises radio front end circuitry 1312 and antenna 1311. Radio front end circuitry 1312 comprise one or more filters 1318 and amplifiers 1316. Radio front end circuitry 1312 is connected to antenna 1311 and processing circuitry 1320, and is configured to condition signals communicated between antenna 1311 and processing circuitry 1320. Radio front end circuitry 1312 may be coupled to or a part of antenna 1311. In some embodiments, WD 1310 may not include separate radio front end circuitry 1312; rather, processing circuitry 1320 may comprise radio front end circuitry and may be connected to antenna 1311. Similarly, in some embodiments, some or all of RF transceiver circuitry 1322 may be considered a part of interface 1314. Radio front end circuitry 1312 may receive digital data that is to be sent out to other network nodes or WDs via a wireless connection. Radio front end circuitry 1312 may convert the digital data into a radio signal having the appropriate channel and bandwidth parameters using a combination of filters 1318 and/or amplifiers 1316. The radio signal may then be transmitted via antenna 1311. Similarly, when receiving data, antenna 1311 may collect radio signals which are then converted into digital data by radio front end circuitry 1312. The digital data may be passed to processing circuitry 1320. In other embodiments, the interface may comprise different components and/or different combinations of components.

Processing circuitry 1320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1310 components, such as device readable medium 1330, WD 1310 functionality. Such functionality may include providing any of the various wireless features or benefits discussed herein. For example, processing circuitry 1320 may execute instructions stored in device readable medium 1330 or in memory within processing circuitry 1320 to provide the functionality disclosed herein.

As illustrated, processing circuitry 1320 includes one or more of RF transceiver circuitry 1322, baseband processing circuitry 1324, and application processing circuitry 1326. In other embodiments, the processing circuitry may comprise different components and/or different combinations of components. In certain embodiments processing circuitry 1320 of WD 1310 may comprise a SOC. In some embodiments, RF transceiver circuitry 1322, baseband processing circuitry 1324, and application processing circuitry 1326 may be on separate chips or sets of chips. In alternative embodiments, part or all of baseband processing circuitry 1324 and application processing circuitry 1326 may be combined into one chip or set of chips, and RF transceiver circuitry 1322 may be on a separate chip or set of chips. In still alternative embodiments, part or all of RF transceiver circuitry 1322 and baseband processing circuitry 1324 may be on the same chip or set of chips, and application processing circuitry 1326 may be on a separate chip or set of chips. In yet other alternative embodiments, part or all of RF transceiver circuitry 1322, baseband processing circuitry 1324, and application processing circuitry 1326 may be combined in the same chip or set of chips. In some embodiments, RF transceiver circuitry 1322 may be a part of interface 1314. RF transceiver circuitry 1322 may condition RF signals for processing circuitry 1320.

In certain embodiments, some or all of the functionality described herein as being performed by a WD may be provided by processing circuitry 1320 executing instructions stored on device readable medium 1330, which in certain embodiments may be a computer-readable storage medium. In alternative embodiments, some or all of the functionality may be provided by processing circuitry 1320 without executing instructions stored on a separate or discrete device readable storage medium, such as in a hard-wired manner In any of those particular embodiments, whether executing instructions stored on a device readable storage medium or not, processing circuitry 1320 can be configured to perform the described functionality. The benefits provided by such functionality are not limited to processing circuitry 1320 alone or to other components of WD 1310, but are enjoyed by WD 1310 as a whole, and/or by end users and the wireless network generally.

Processing circuitry 1320 may be configured to perform any determining, calculating, or similar operations (e.g., certain obtaining operations) described herein as being performed by a WD. These operations, as performed by processing circuitry 1320, may include processing information obtained by processing circuitry 1320 by, for example, converting the obtained information into other information, comparing the obtained information or converted information to information stored by WD 1310, and/or performing one or more operations based on the obtained information or converted information, and as a result of said processing making a determination.

Device readable medium 1330 may be operable to store a computer program, software, an application including one or more of logic, rules, code, tables, etc. and/or other instructions capable of being executed by processing circuitry 1320. Device readable medium 1330 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1320. In some embodiments, processing circuitry 1320 and device readable medium 1330 may be considered to be integrated.

User interface equipment 1332 may provide components that allow for a human user to interact with WD 1310. Such interaction may be of many forms, such as visual, audial, tactile, etc. User interface equipment 1332 may be operable to produce output to the user and to allow the user to provide input to WD 1310. The type of interaction may vary depending on the type of user interface equipment 1332 installed in WD 1310. For example, if WD 1310 is a smart phone, the interaction may be via a touch screen; if WD 1310 is a smart meter, the interaction may be through a screen that provides usage (e.g., the number of gallons used) or a speaker that provides an audible alert (e.g., if smoke is detected). User interface equipment 1332 may include input interfaces, devices and circuits, and output interfaces, devices and circuits. User interface equipment 1332 is configured to allow input of information into WD 1310, and is connected to processing circuitry 1320 to allow processing circuitry 1320 to process the input information. User interface equipment 1332 may include, for example, a microphone, a proximity or other sensor, keys/buttons, a touch display, one or more cameras, a USB port, or other input circuitry. User interface equipment 1332 is also configured to allow output of information from WD 1310, and to allow processing circuitry 1320 to output information from WD 1310. User interface equipment 1332 may include, for example, a speaker, a display, vibrating circuitry, a USB port, a headphone interface, or other output circuitry. Using one or more input and output interfaces, devices, and circuits, of user interface equipment 1332, WD 1310 may communicate with end users and/or the wireless network, and allow them to benefit from the functionality described herein.

Auxiliary equipment 1334 is operable to provide more specific functionality which may not be generally performed by WDs. This may comprise specialized sensors for doing measurements for various purposes, interfaces for additional types of communication such as wired communications etc. The inclusion and type of components of auxiliary equipment 1334 may vary depending on the embodiment and/or scenario.

Power source 1336 may, in some embodiments, be in the form of a battery or battery pack. Other types of power sources, such as an external power source (e.g., an electricity outlet), photovoltaic devices or power cells, may also be used. WD 1310 may further comprise power circuitry 1337 for delivering power from power source 1336 to the various parts of WD 1310 which need power from power source 1336 to carry out any functionality described or indicated herein. Power circuitry 1337 may in certain embodiments comprise power management circuitry. Power circuitry 1337 may additionally or alternatively be operable to receive power from an external power source; in which case WD 1310 may be connectable to the external power source (such as an electricity outlet) via input circuitry or an interface such as an electrical power cable. Power circuitry 1337 may also in certain embodiments be operable to deliver power from an external power source to power source 1336. This may be, for example, for the charging of power source 1336. Power circuitry 1337 may perform any formatting, converting, or other modification to the power from power source 1336 to make the power suitable for the respective components of WD 1310 to which power is supplied.

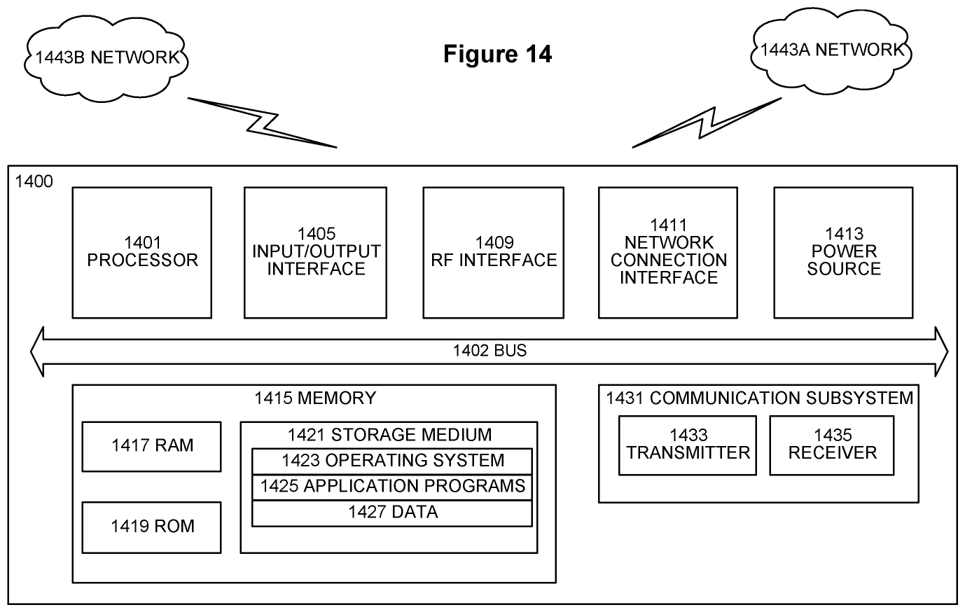

FIG. 14 illustrates a user Equipment in accordance with some embodiments.

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1400 may be any UE identified by the 3rd Generation Partnership Project (3GPP), including a NB-IoT UE, a machine type communication (MTC) UE, and/or an enhanced MTC (eMTC) UE. UE 1400, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 1400 includes processing circuitry 1401 that is operatively coupled to input/output interface 1405, radio frequency (RF) interface 1409, network connection interface 1411, memory 1415 including random access memory (RAM) 1417, read-only memory (ROM) 1419, and storage medium 1421 or the like, communication subsystem 1431, power source 1413, and/or any other component, or any combination thereof. Storage medium 1421 includes operating system 1423, application program 1425, and data 1427. In other embodiments, storage medium 1421 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1401 may be configured to process computer instructions and data. Processing circuitry 1401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1401 may include two central processing units (CPUs). Data may be information in a form suitable for use by a computer.

In the depicted embodiment, input/output interface 1405 may be configured to provide a communication interface to an input device, output device, or input and output device. UE 1400 may be configured to use an output device via input/output interface 1405. An output device may use the same type of interface port as an input device. For example, a USB port may be used to provide input to and output from UE 1400. The output device may be a speaker, a sound card, a video card, a display, a monitor, a printer, an actuator, an emitter, a smartcard, another output device, or any combination thereof. UE 1400 may be configured to use an input device via input/output interface 1405 to allow a user to capture information into UE 1400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1409 may be configured to provide a communication interface to RF components such as a transmitter, a receiver, and an antenna. Network connection interface 1411 may be configured to provide a communication interface to network 1443a. Network 1443a may encompass wired and/or wireless networks such as a local-area network (LAN), a wide-area network (WAN), a computer network, a wireless network, a telecommunications network, another like network or any combination thereof. For example, network 1443a may comprise a Wi-Fi network. Network connection interface 1411 may be configured to include a receiver and a transmitter interface used to communicate with one or more other devices over a communication network according to one or more communication protocols, such as Ethernet, TCP/IP, SONET, ATM, or the like. Network connection interface 1411 may implement receiver and transmitter functionality appropriate to the communication network links (e.g., optical, electrical, and the like). The transmitter and receiver functions may share circuit components, software or firmware, or alternatively may be implemented separately.

RAM 1417 may be configured to interface via bus 1402 to processing circuitry 1401 to provide storage or caching of data or computer instructions during the execution of software programs such as the operating system, application programs, and device drivers. ROM 1419 may be configured to provide computer instructions or data to processing circuitry 1401. For example, ROM 1419 may be configured to store invariant low-level system code or data for basic system functions such as basic input and output (I/O), startup, or reception of keystrokes from a keyboard that are stored in a non-volatile memory. Storage medium 1421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1421 may be configured to include operating system 1423, application program 1425 such as a web browser application, a widget or gadget engine or another application, and data file 1427. Storage medium 1421 may store, for use by UE 1400, any of a variety of various operating systems or combinations of operating systems.

Storage medium 1421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1421 may allow UE 1400 to access computer-executable instructions, application programs or the like, stored on transitory or non-transitory memory media, to off-load data, or to upload data. An article of manufacture, such as one utilizing a communication system may be tangibly embodied in storage medium 1421, which may comprise a device readable medium.

In FIG. 14, processing circuitry 1401 may be configured to communicate with network 1443b using communication subsystem 1431. Network 1443a and network 1443b may be the same network or networks or different network or networks. Communication subsystem 1431 may be configured to include one or more transceivers used to communicate with network 1443b. For example, communication subsystem 1431 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1433 and/or receiver 1435 to implement transmitter or receiver functionality, respectively, appropriate to the RAN links (e.g., frequency allocations and the like). Further, transmitter 1433 and receiver 1435 of each transceiver may share circuit components, software or firmware, or alternatively may be implemented separately.

In the illustrated embodiment, the communication functions of communication subsystem 1431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1431 may include cellular communication, Wi-Fi communication, Bluetooth communication, and GPS communication. Network 1443b may encompass wired and/or wireless networks such as a local-area network (LAN), a wide-area network (WAN), a computer network, a wireless network, a telecommunications network, another like network or any combination thereof. For example, network 1443b may be a cellular network, a Wi-Fi network, and/or a near-field network. Power source 1413 may be configured to provide alternating current (AC) or direct current (DC) power to components of UE 1400.

The features, benefits and/or functions described herein may be implemented in one of the components of UE 1400 or partitioned across multiple components of UE 1400. Further, the features, benefits, and/or functions described herein may be implemented in any combination of hardware, software or firmware. In one example, communication subsystem 1431 may be configured to include any of the components described herein. Further, processing circuitry 1401 may be configured to communicate with any of such components over bus 1402. In another example, any of such components may be represented by program instructions stored in memory that when executed by processing circuitry 1401 perform the corresponding functions described herein. In another example, the functionality of any of such components may be partitioned between processing circuitry 1401 and communication subsystem 1431. In another example, the non-computationally intensive functions of any of such components may be implemented in software or firmware and the computationally intensive functions may be implemented in hardware.

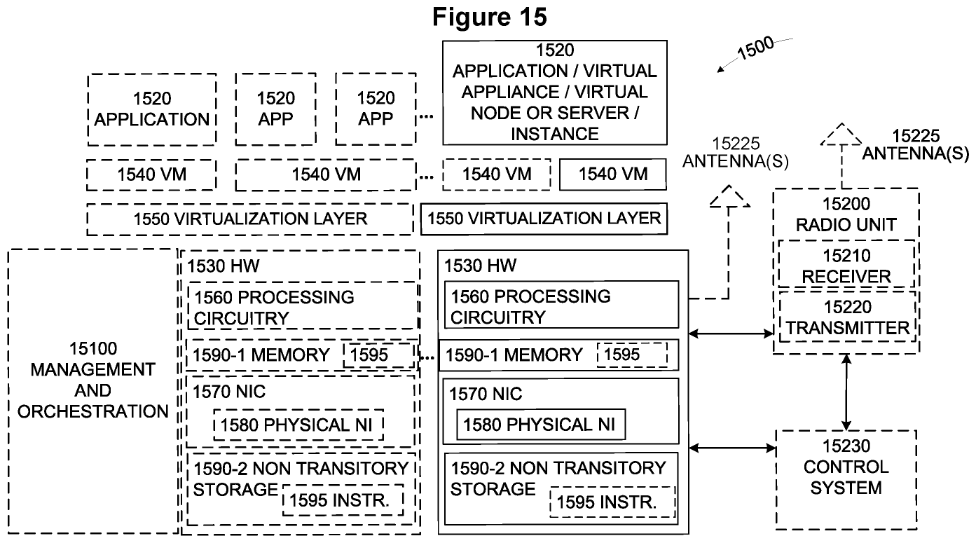

FIG. 15 illustrates a virtualization environment in accordance with some embodiments.

FIG. 15 is a schematic block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1500 hosted by one or more of hardware nodes 1530. Further, in embodiments in which the virtual node is not a radio access node or does not require radio connectivity (e.g., a core network node), then the network node may be entirely virtualized.

The functions may be implemented by one or more applications 1520 (which may alternatively be called software instances, virtual appliances, network functions, virtual nodes, virtual network functions, etc.) operative to implement some of the features, functions, and/or benefits of some of the embodiments disclosed herein. Applications 1520 are run in virtualization environment 1500 which provides hardware 1530 comprising processing circuitry 1560 and memory 1590. Memory 1590 contains instructions 1595 executable by processing circuitry 1560 whereby application 1520 is operative to provide one or more of the features, benefits, and/or functions disclosed herein.

Virtualization environment 1500, comprises general-purpose or special-purpose network hardware devices 1530 comprising a set of one or more processors or processing circuitry 1560, which may be commercial off-the-shelf (COTS) processors, dedicated Application Specific Integrated Circuits (ASICs), or any other type of processing circuitry including digital or analog hardware components or special purpose processors. Each hardware device may comprise memory 1590-1 which may be non-persistent memory for temporarily storing instructions 1595 or software executed by processing circuitry 1560. Each hardware device may comprise one or more network interface controllers (NICs) 1570, also known as network interface cards, which include physical network interface 1580. Each hardware device may also include non-transitory, persistent, machine-readable storage media 1590-2 having stored therein software 1595 and/or instructions executable by processing circuitry 1560. Software 1595 may include any type of software including software for instantiating one or more virtualization layers 1550 (also referred to as hypervisors), software to execute virtual machines 1540 as well as software allowing it to execute functions, features and/or benefits described in relation with some embodiments described herein.

Virtual machines 1540 comprise virtual processing, virtual memory, virtual networking or interface and virtual storage, and may be run by a corresponding virtualization layer 1550 or hypervisor. Different embodiments of the instance of virtual appliance 1520 may be implemented on one or more of virtual machines 1540, and the implementations may be made in different ways.

During operation, processing circuitry 1560 executes software 1595 to instantiate the hypervisor or virtualization layer 1550, which may sometimes be referred to as a virtual machine monitor (VMM). Virtualization layer 1550 may present a virtual operating platform that appears like networking hardware to virtual machine 1540.

As shown in FIG. 15, hardware 1530 may be a standalone network node with generic or specific components. Hardware 1530 may comprise antenna 15225 and may implement some functions via virtualization. Alternatively, hardware 1530 may be part of a larger cluster of hardware (e.g. such as in a data center or customer premise equipment (CPE)) where many hardware nodes work together and are managed via management and orchestration (MANO) 15100, which, among others, oversees lifecycle management of applications 1520.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1540 may be a software implementation of a physical machine that runs programs as if they were executing on a physical, non-virtualized machine. Each of virtual machines 1540, and that part of hardware 1530 that executes that virtual machine, be it hardware dedicated to that virtual machine and/or hardware shared by that virtual machine with others of the virtual machines 1540, forms a separate virtual network elements (VNE).

Still in the context of NFV, Virtual Network Function (VNF) is responsible for handling specific network functions that run in one or more virtual machines 1540 on top of hardware networking infrastructure 1530 and corresponds to application 1520 in FIG. 15.

In some embodiments, one or more radio units 15200 that each include one or more transmitters 15220 and one or more receivers 15210 may be coupled to one or more antennas 15225. Radio units 15200 may communicate directly with hardware nodes 1530 via one or more appropriate network interfaces and may be used in combination with the virtual components to provide a virtual node with radio capabilities, such as a radio access node or a base station.

In some embodiments, some signalling can be effected with the use of control system 15230 which may alternatively be used for communication between the hardware nodes 1530 and radio units 15200.

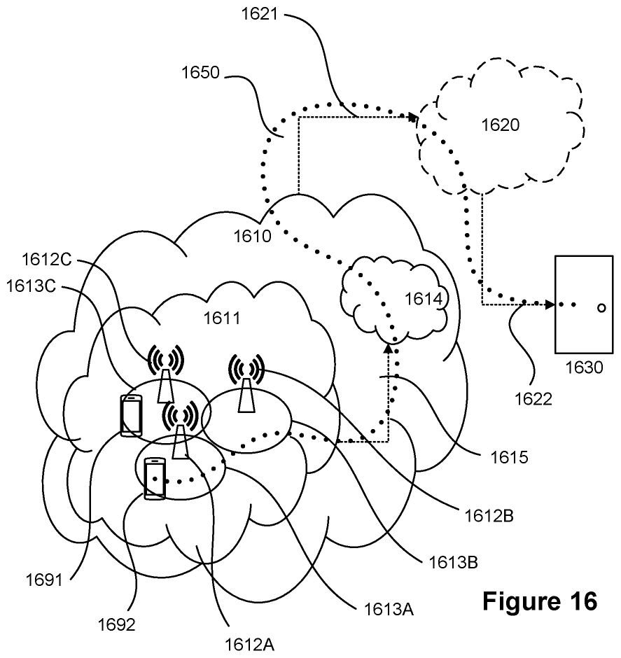

FIG. 16 illustrates a telecommunication network connected via an intermediate network to a host computer in accordance with some embodiments.

With reference to FIG. 16, in accordance with an embodiment, a communication system includes telecommunication network 1610, such as a 3GPP-type cellular network, which comprises access network 1611, such as a radio access network, and core network 1614. Access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to core network 1614 over a wired or wireless connection 1615. A first UE 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

Telecommunication network 1610 is itself connected to host computer 1630, which may be embodied in the hardware and/or software of a standalone server, a cloud-implemented server, a distributed server or as processing resources in a server farm. Host computer 1630 may be under the ownership or control of a service provider, or may be operated by the service provider or on behalf of the service provider. Connections 1621 and 1622 between telecommunication network 1610 and host computer 1630 may extend directly from core network 1614 to host computer 1630 or may go via an optional intermediate network 1620. Intermediate network 1620 may be one of, or a combination of more than one of, a public, private or hosted network; intermediate network 1620, if any, may be a backbone network or the Internet; in particular, intermediate network 1620 may comprise two or more sub-networks (not shown).

The communication system of FIG. 16 as a whole enables connectivity between the connected UEs 1691, 1692 and host computer 1630. The connectivity may be described as an over-the-top (OTT) connection 1650. Host computer 1630 and the connected UEs 1691, 1692 are configured to communicate data and/or signaling via OTT connection 1650, using access network 1611, core network 1614, any intermediate network 1620 and possible further infrastructure (not shown) as intermediaries. OTT connection 1650 may be transparent in the sense that the participating communication devices through which OTT connection 1650 passes are unaware of routing of uplink and downlink communications. For example, base station 1612 may not or need not be informed about the past routing of an incoming downlink communication with data originating from host computer 1630 to be forwarded (e.g., handed over) to a connected UE 1691. Similarly, base station 1612 need not be aware of the future routing of an outgoing uplink communication originating from the UE 1691 towards the host computer 1630.

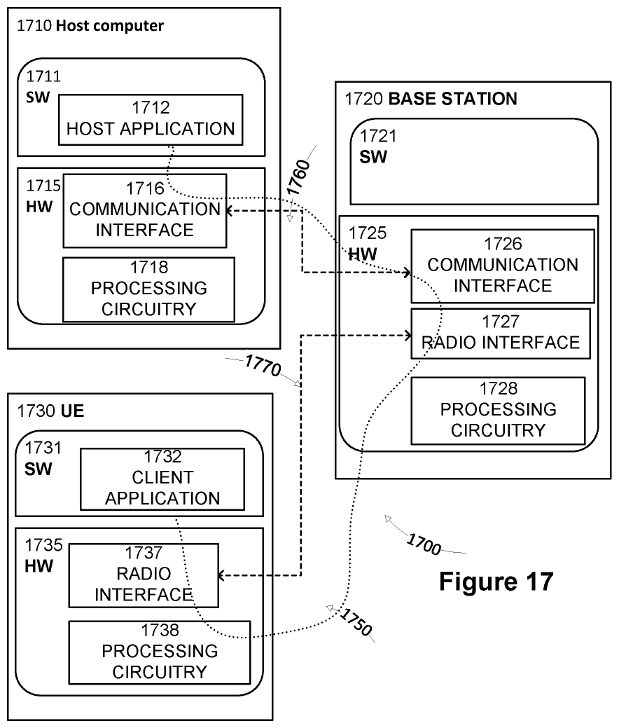

FIG. 17 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 17. In communication system 1700, host computer 1710 comprises hardware 1715 including communication interface 1716 configured to set up and maintain a wired or wireless connection with an interface of a different communication device of communication system 1700. Host computer 1710 further comprises processing circuitry 1718, which may have storage and/or processing capabilities. In particular, processing circuitry 1718 may comprise one or more programmable processors, application-specific integrated circuits, field programmable gate arrays or combinations of these (not shown) adapted to execute instructions. Host computer 1710 further comprises software 1711, which is stored in or accessible by host computer 1710 and executable by processing circuitry 1718. Software 1711 includes host application 1712. Host application 1712 may be operable to provide a service to a remote user, such as UE 1730 connecting via OTT connection 1750 terminating at UE 1730 and host computer 1710. In providing the service to the remote user, host application 1712 may provide user data which is transmitted using OTT connection 1750.

Communication system 1700 further includes base station 1720 provided in a telecommunication system and comprising hardware 1725 enabling it to communicate with host computer 1710 and with UE 1730. Hardware 1725 may include communication interface 1726 for setting up and maintaining a wired or wireless connection with an interface of a different communication device of communication system 1700, as well as radio interface 1727 for setting up and maintaining at least wireless connection 1770 with UE 1730 located in a coverage area (not shown in FIG. 17) served by base station 1720. Communication interface 1726 may be configured to facilitate connection 1760 to host computer 1710. Connection 1760 may be direct or it may pass through a core network (not shown in FIG. 17) of the telecommunication system and/or through one or more intermediate networks outside the telecommunication system. In the embodiment shown, hardware 1725 of base station 1720 further includes processing circuitry 1728, which may comprise one or more programmable processors, application-specific integrated circuits, field programmable gate arrays or combinations of these (not shown) adapted to execute instructions. Base station 1720 further has software 1721 stored internally or accessible via an external connection.

Communication system 1700 further includes UE 1730 already referred to. Its hardware 1735 may include radio interface 1737 configured to set up and maintain wireless connection 1770 with a base station serving a coverage area in which UE 1730 is currently located. Hardware 1735 of UE 1730 further includes processing circuitry 1738, which may comprise one or more programmable processors, application-specific integrated circuits, field programmable gate arrays or combinations of these (not shown) adapted to execute instructions. UE 1730 further comprises software 1731, which is stored in or accessible by UE 1730 and executable by processing circuitry 1738. Software 1731 includes client application 1732. Client application 1732 may be operable to provide a service to a human or non-human user via UE 1730, with the support of host computer 1710. In host computer 1710, an executing host application 1712 may communicate with the executing client application 1732 via OTT connection 1750 terminating at UE 1730 and host computer 1710. In providing the service to the user, client application 1732 may receive request data from host application 1712 and provide user data in response to the request data. OTT connection 1750 may transfer both the request data and the user data. Client application 1732 may interact with the user to generate the user data that it provides.

It is noted that host computer 1710, base station 1720 and UE 1730 illustrated in FIG. 17 may be similar or identical to host computer 1630, one of base stations 1612a, 1612b, 1612c and one of UEs 1691, 1692 of FIG. 16, respectively. This is to say, the inner workings of these entities may be as shown in FIG. 17 and independently, the surrounding network topology may be that of FIG. 16.

In FIG. 17, OTT connection 1750 has been drawn abstractly to illustrate the communication between host computer 1710 and UE 1730 via base station 1720, without explicit reference to any intermediary devices and the precise routing of messages via these devices. Network infrastructure may determine the routing, which it may be configured to hide from UE 1730 or from the service provider operating host computer 1710, or both. While OTT connection 1750 is active, the network infrastructure may further take decisions by which it dynamically changes the routing (e.g., on the basis of load balancing consideration or reconfiguration of the network).

Wireless connection 1770 between UE 1730 and base station 1720 is in accordance with the teachings of the embodiments described throughout this disclosure. One or more of the various embodiments may improve the performance of OTT services provided to UE 1730 using OTT connection 1750, in which wireless connection 1770 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 1750 between host computer 1710 and UE 1730, in response to variations in the measurement results. The measurement procedure and/or the network functionality for reconfiguring OTT connection 1750 may be implemented in software 1711 and hardware 1715 of host computer 1710 or in software 1731 and hardware 1735 of UE 1730, or both. In embodiments, sensors (not shown) may be deployed in or in association with communication devices through which OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of OTT connection 1750 may include message format, retransmission settings, preferred routing etc.; the reconfiguring need not affect base station 1720, and it may be unknown or imperceptible to base station 1720. Such procedures and functionalities may be known and practiced in the art. In certain embodiments, measurements may involve proprietary UE signaling facilitating host computer 1710's measurements of throughput, propagation times, latency and the like. The measurements may be implemented in that software 1711 and 1731 causes messages to be transmitted, in particular empty or ‘dummy’ messages, using OTT connection 1750 while it monitors propagation times, errors etc.

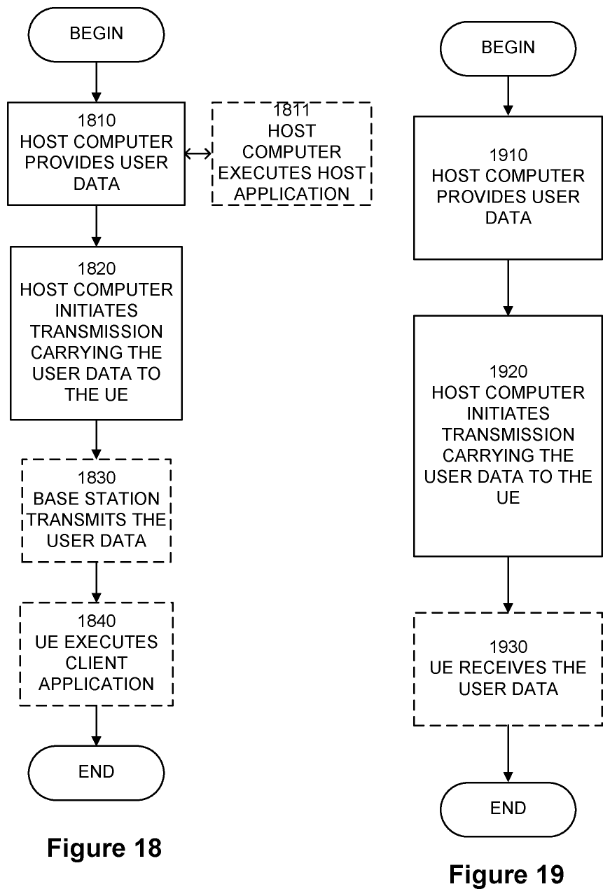

FIG. 18 illustrates methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 1810, the host computer provides user data. In substep 1811 (which may be optional) of step 1810, the host computer provides the user data by executing a host application. In step 1820, the host computer initiates a transmission carrying the user data to the UE. In step 1830 (which may be optional), the base station transmits to the UE the user data which was carried in the transmission that the host computer initiated, in accordance with the teachings of the embodiments described throughout this disclosure. In step 1840 (which may also be optional), the UE executes a client application associated with the host application executed by the host computer.

FIG. 19 illustrates methods implemented in a communication system including a host computer, a base station and a user equipment in accordance with some embodiments.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 1910 of the method, the host computer provides user data. In an optional substep (not shown) the host computer provides the user data by executing a host application. In step 1920, the host computer initiates a transmission carrying the user data to the UE. The transmission may pass via the base station, in accordance with the teachings of the embodiments described throughout this disclosure. In step 1930 (which may be optional), the UE receives the user data carried in the transmission.

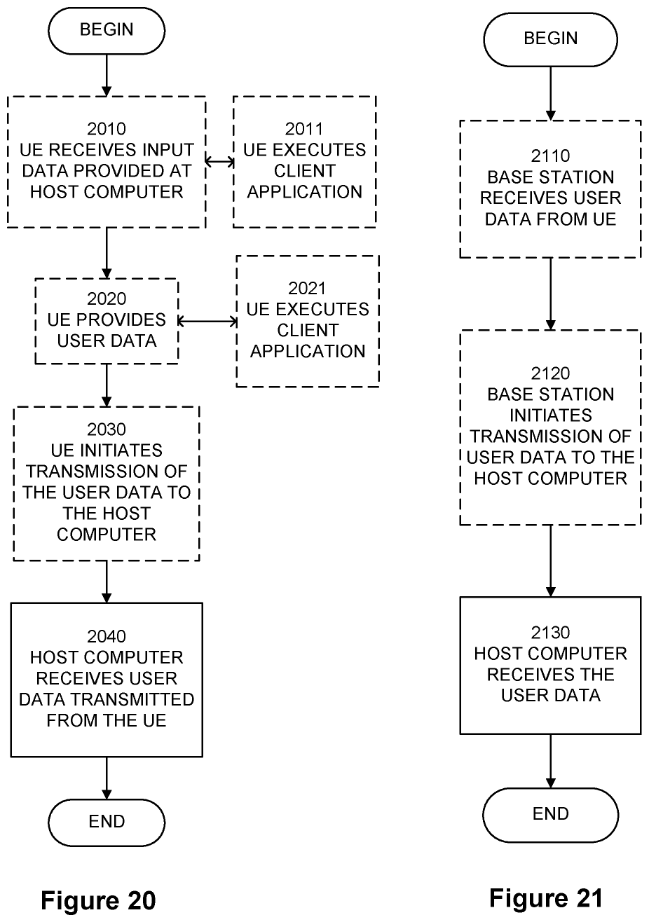

FIG. 20 illustrates methods implemented in a communication system including a host computer, a base station and a user equipment in accordance with some embodiments

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 2010 (which may be optional), the UE receives input data provided by the host computer. Additionally or alternatively, in step 2020, the UE provides user data. In substep 2021 (which may be optional) of step 2020, the UE provides the user data by executing a client application. In substep 2011 (which may be optional) of step 2010, the UE executes a client application which provides the user data in reaction to the received input data provided by the host computer. In providing the user data, the executed client application may further consider user input received from the user. Regardless of the specific manner in which the user data was provided, the UE initiates, in substep 2030 (which may be optional), transmission of the user data to the host computer. In step 2040 of the method, the host computer receives the user data transmitted from the UE, in accordance with the teachings of the embodiments described throughout this disclosure.

FIG. 21 illustrates methods implemented in a communication system including a host computer, a base station and a user equipment in accordance with some embodiments

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 2110 (which may be optional), in accordance with the teachings of the embodiments described throughout this disclosure, the base station receives user data from the UE. In step 2120 (which may be optional), the base station initiates transmission of the received user data to the host computer. In step 2130 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1×Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a wireless communication device, enabled to perform a Dual Active Protocol Stack (DAPS) handover, HO, from a source node/cell to a target node/cell, the method comprising:
responsive to detecting a radio link failure, RLF, on a source link between the wireless communication device and the source node/cell, generating a RLF report related to the source node/cell;
responsive to detecting a RLF on a target link between the wireless communication device and the target node/cell, generating a RLF report related to the target node/cell;
including an indication on a subsequent uplink radio resource control, RRC, message to a network node that the wireless communication device has one or more RLF reports related to DAPS HO failure;
responsive to receiving a request from the network node to send the one or more RLF reports, transmitting the one or more RLF reports to the network node.

2. The method of claim 1, further comprising storing the RLF report related to the source node/cell.

3. The method of claim 1, further comprising storing the RLF report related to the target node/cell.

4. The method of claim 2 wherein storing the RLF report comprises storing each RLF report with a same RLF report information element.

5. The method of claim 2 wherein storing the RLF report comprises storing each RLF report in a RLF report information element such that each RLF report information element contains only one RLF report.

6. The method of claim 1 wherein the indication that the one or more RLF reports are related to DAPS HO failure is included in a RLF cause value.

7. The method of claim 1 wherein the indication that the one or more RLF reports are related to DAPS HO failure is provided in an information element for indicating DAP HO failure.

8. A method performed by a first network node providing connectivity to a wireless communication device in a wireless network, the method comprising:
receiving a notification from the wireless communication device that the wireless communication device has a radio link failure, RLF, report;
transmitting an instruction message to the wireless communication device instructing the wireless communication device to send the RLF report;
receiving the RLF report;
responsive to the RLF report containing information about a failure during dual active protocol stack handover, DAPS HO, and the RLF report contains failure information related to a source node serving a source cell and the first network node is different from the source node serving the source cell, forwarding the RLF report to the source node serving the source cell;
responsive to the RLF report containing information about a failure during DAPS HO and the RLF report contains failure information related to a target node serving a target cell and the first network node is different from the target node serving the target cell, forwarding the RLF report to the target node serving the target cell; and
responsive to the RLF report containing information about a failure during DAPS HO and the RLF report contains failure information related to a source cell and a target cell and the first network node is different from the source node serving the source cell and from the target node serving the target cell, forwarding the RLF report to the source node serving the source cell and the target node serving the target cell.

9. The method of claim 8, further comprising forwarding the RLF report to at least one network node handling self organizing network/minimization of drive testing, SON/MDT, in the wireless network.

10. The method of claim 8 wherein forwarding the RLF report to the source node serving the source cell comprises forwarding the RLF report to the source node serving the source cell via X2/Xn message/signaling and forwarding the RLF report to the target node serving the target cell comprises forwarding the RLF report to the target node serving the target cell via X2/Xn message/signaling.

11. The method of claim 8 wherein forwarding the RLF report to the source node serving the source cell comprises forwarding the RLF report to the source node serving the source cell via inter-node radio resource control, RRC, messages.

12. The method of claim 8, wherein forwarding the RLF report to the target node serving the target cell comprises forwarding the RLF report to the target node serving the target cell via inter-node radio resource control, RRC, messages.

13. The method of claim 8, wherein responsive to at least one of the source node and the target node employing a centralized unit/distributed unit, CU/DU, split architecture, forwarding the RLF report comprises forwarding the RLF report to the CU of the at least one of the source node and the target node.

14. The method of claim 8, wherein transmitting the RLF report to the source node and transmitting the RLF report to the target node comprises transmitting the RLF report to the source node via a core network function/node and transmitting the RLF report to the target node via the core network function/node.

15. The method of claim 14 wherein the core network function/node comprises an access and mobility management function, AMF, function/node.

16. A wireless communication device adapted to perform operations comprising:
responsive to detecting a radio link failure, RLF, on a source link between the wireless communication device and a source node/cell, generating a RLF report related to the source node/cell;
responsive to detecting a RLF on a target link between the wireless communication device and a target node/cell, generating a RLF report related to the target node/cell;
including an indication on a subsequent uplink radio resource control, RRC, message to a network node that the wireless communication device has one or more RLF reports related to DAPS HO failure;
responsive to receiving a request from the network node to send the one or more RLF reports, transmitting the one or more RLF reports to the network node.

17. The wireless communication device of claim 16, wherein the wireless communication device is further adapted to perform operations comprising
storing the RLF report related to the source node/cell; and
storing the RLF report related to the target node/cell.

18. The wireless communication device of claim 17 wherein storing the RLF report comprises storing each RLF report with a same RLF report information element.

19. The wireless communication device of claim 17 wherein storing the RLF report comprises storing each RLF report in a RLF report information element such that each RLF report information element contains only one RLF report.

20. The wireless communication device of claim 17 wherein the indication that the one or more RLF reports are related to DAPS HO failure is included in a RLF cause value.

21. The wireless communication device of claim 17 wherein the indication that the one or more RLF reports are related to DAPS HO failure is provided in an information element for indicating DAP HO failure.

22. A first network node in a wireless network, the first network node adapted to perform operations comprising:
receiving a notification from a wireless communication device that the wireless communication device has a radio link failure, RLF, report;
transmitting an instruction message to the wireless communication device instructing the wireless communication device to send the RLF report;
receiving the RLF report;
responsive to the RLF report containing information about a failure during dual active protocol stack handover, DAPS HO, and the RLF report contains failure information related to a source node serving a source cell and the first network node is different from the source node serving the source cell, forwarding the RLF report to the source node serving the source cell;
responsive to the RLF report containing information about a failure during DAPS HO and the RLF report contains failure information related to a target node serving a target cell and the first network node is different from the target node serving the target cell, forwarding the RLF report to the target node serving the target cell; and
responsive to the RLF report containing information about a failure during DAPS HO and the RLF report contains failure information related to a source cell and a target cell and the first network node is different from the source node serving the source cell and from the target node serving the target cell, forwarding the RLF report to the source node serving the source cell and the target node serving the target cell.

23.-32. (canceled)
